(19) United States
(12) Patent Application Publication
(10) Pub. No.: US 2017/0271912 A1
(43) Pub. Date: Sep. 21, 2017

(54) DISPATCHABLE PHOTOVOLTAIC PANEL WITH FULLY INTEGRATED ENERGY STORAGE AND GRID INTERACTIVE POWER CONVERSION

(71) Applicants: SINEWATTS, INC., Charlotte, NC (US); THE UNIVERSITY OF NORTH CAROLINA AT CHARLOTTE, Charlotte, NC (US)

(72) Inventors: Shibashis BHOWMIK, Charlotte, NC (US); Robert W. COX, Charlotte, NC (US); Babak PARKHIDEH, Charlotte, NC (US)

(21) Appl. No.: 15/532,072

(22) PCT Filed: Dec. 15, 2015
(86) PCT No.: PCT/US15/65913

§ 371 Date: May 31, 2017

Related U.S. Application Data
(60) Provisional application No. 62/092,824, filed on Dec. 16, 2014.

(51) Int. Cl. H02J 7/35; H02S 40/38; H02S 50/00; H02S 40/42; H02J 7/00; H02S 40/32; H02S 10/40

(52) U.S. Cl. CPC H02J 7/35; H02S 40/32; H02S 40/38; H02S 10/40; H02S 40/42; H02J 7/0029; H02S 50/00

(57) ABSTRACT

A dispatchable photovoltaic (PV) panel product that includes multiple types of voltage sources is described. The product can include a PV panel that includes PV cells, a battery, and a panel level panel mounted inverter coupled to the PV panel and the battery. Each of the battery and the PV panel are to generate direct current (DC) power. The panel level inverter is to convert the DC power into alternating current (AC) power and discharge the AC power to an electrical load. The panel level inverter can include a voltage source interface converter (VSIC) for charging or discharging the battery using a charge/discharge profile for the battery. The panel level inverter can also include a voltage source monitoring/protection system to (i) protect the battery from damage; and (ii) monitor at least one of a condition of the battery or a condition of the PV panel.

### RELATED APPLICATIONS

This application claims, under 35 U.S.C. 119(e), the benefit of priority from U.S. Provisional Patent Application Ser. No. 62/092,824, filed on Dec. 16, 2014, the full disclosure of which is incorporated herein by reference.

### STATEMENT REGARDING FEDERALLY SPONSORED RESEARCH OR DEVELOPMENT

The embodiments described herein and the work that resulted in those embodiments was funded, in part, by the Office of Energy Efficiency and Renewable Energy (EERE), U.S. Department of Energy, under Award Number DE-EE0006692. The embodiments described herein and the work that resulted in those embodiments is part of activities being performed under the U.S. Department of Energy (DoE), SunShot Incubator Program, Round 9. The U.S. government may have certain rights in the embodiments described herein.

### FIELD

Embodiments described herein relate generally to the field of photovoltaic (PV) power generation; and more specifically, to systems, apparatuses, and methods for a dispatchable PV panel product that includes multiple types of voltage sources.

### BACKGROUND

Some typical photovoltaic (PV) power plants include typical grid-scale energy storage systems (e.g., flow batteries, large pumped-water storage systems, air storage systems, etc.). In some scenarios, these typical grid-scale energy storage systems can exhibit suboptimal energy densities. Consequently, some typical PV power plants can suffer from several shortcomings, which include high installation costs, lack of guaranteed plant availability, lack of panel-level optimization, and occurrence of one or more single points of failure that lead to inherently low reliability of these typical PV plants. These shortcomings can exacerbate the high costs associated with these types of PV plants—e.g., a substantial footprint, high installation costs, expensive energy balancing and monitoring systems, etc.

### SUMMARY

Embodiments described herein relate to systems, apparatuses, and methods for a dispatchable PV panel product. Dispatchability is defined as the ability of the grid operator (vertically integrated utilities, regional transmission operators (RTOs)) to dispatch a generating resource to deliver energy to the grid. Renewable energy, such as solar PV is an intermittent resource due to cloud cover, shading and other occlusion scenarios. Without guaranteed capacity availability grid operators lack the ability to dispatch these resources thereby requiring them to maintain expensive spinning reserves. PV coupled with energy storage allows guaranteed operation for longer durations under occluded conditions and minimizes the impact of intermittency, hence, making these generating resources dispatchable. For an embodiment, a dispatchable photovoltaic (PV) panel product includes the following: (i) multiple types of voltage sources including a PV panel comprised of one or more PV cells and a battery (e.g., a rechargeable lithium-ion battery, etc.); and (ii) a panel mounted inverter that includes at least one of a voltage source interface converter (VSIC) or a voltage source monitoring/protection system. For one embodiment, the multiple types of voltage sources include at least two different types of voltage sources—(i) a PV panel for power generation; and (ii) a battery for power storage. For one embodiment, the voltage source monitoring/protection system is to monitor a condition of at least one of the battery or the PV panel. For one embodiment, the monitored condition of the battery is converted into electronic data that is used to create a charge/discharge profile for the battery. The monitored condition of the PV panel coupled with its I-V sweep can be used to create an accurate model for the PV panel that may be utilized to determine present and predict future panel capacity.

The monitored condition of the battery of the dispatchable PV panel product can include at least one of the following: (i) a yield of the battery, where the yield of the battery is a measure of energy derived from the power generated by the battery; (ii) a temperature characteristic of the battery; (iii) a voltage characteristic of the battery; or (iv) a current characteristic of the battery. The monitored condition of the PV panel of the dispatchable PV panel product can include at least one of the following: (i) a yield of the PV panel, where the yield of the PV panel is a measure of energy derived from the power generated by the PV panel; (ii) a temperature characteristic of the PV panel; (iii) a voltage characteristic of the PV panel; or (iv) a current characteristic of the PV panel.

For one embodiment, the voltage source monitoring/protection system protects the battery during a charging/discharging process, where the voltage source monitoring/protection system protects the battery from damage by detecting one or more potential hazardous situations associated with the battery and initiating a limiting process or shutdown of at least one of the battery or the PV panel of the multiple types of voltage sources in response to the detection. For one embodiment, the VSIC is to perform voltage matching of the PV panel and the battery and to control the charging/discharging process of the battery employing a predetermined charge/discharge profile. For one embodiment, a photovoltaic (PV) power plant includes at least one dispatchable PV panel product, as described above.

For one embodiment, at least one of energy rate arbitrage, supply shifting, PV smoothing, or a grid functionality is performed based on at least one of the monitored conditions of the battery or on at least one of the monitored conditions of the PV panel.

Other advantages and features will become apparent from the accompanying drawings and the following detailed description.

### BRIEF DESCRIPTION OF THE DRAWINGS

Embodiments described herein are illustrated by way of example and not limitation in the figures of the accompanying drawings, in which like references indicate similar elements.

FIG. 1 is a block diagram of one embodiment of a system that includes a dispatchable PV panel product, which includes multiple types of voltage sources in accordance with an embodiment.

FIG. 2A is a pictorial illustration of a dispatchable PV panel product, which includes multiple types of voltage sources in accordance with an embodiment. The PV panel product of FIG. 2A can be included in the system of FIG. 1.

FIG. 2B is a close-up view of the pictorial illustration of the dispatchable PV panel product shown in FIG. 2A.

FIG. 2C is a pictorial illustration of an panel mounted inverter that is part of a dispatchable PV panel product, which includes multiple types of voltage sources in accordance with an embodiment. The panel mounted inverter of FIG. 2C provides additional details about the dispatchable PV panel product of FIGS. 2A-2B.

FIGS. 3A-3C are block diagram illustrations of a dispatchable PV panel product, which includes multiple types of voltage sources in accordance with an embodiment. The dispatchable PV panel product of FIGS. 3A-3C provide additional details about the dispatchable PV panel product of FIGS. 2A-2C.

FIG. 4 is a schematic illustration of a dispatchable PV panel product, which includes multiple types of voltage sources in accordance with another embodiment. The dispatchable PV panel product of FIG. 4 provides additional details about the dispatchable PV panel product of FIG. 2A;

FIG. 5 is a flow chart illustration of a process of battery monitoring and/or protection in accordance with one embodiment.

FIG. 6 is a block diagram illustration of a cloud or appropriately situated system according to an embodiment.

FIG. 7 is a block diagram illustrating an example of a data processing system 700 that may be used with at least one of the embodiments described herein.

### DETAILED DESCRIPTION

Embodiments described herein relate to systems, apparatuses, and methods for a dispatchable PV panel product that includes multiple types of voltage sources.

Embodiments of a dispatchable PV panel product that includes multiple types of voltage sources, as described herein, can assist with (i) reducing high installation costs associated with PV power plants coupled with energy storage; (ii) increasing opportunities for guaranteed plant availability; (iii) increasing opportunities for panel-level optimization; and (iv) reducing the occurrence of points of failure that lead to inherently low reliability of PV plants and energy storage systems. More specifically, the described embodiments of a dispatchable PV panel product can assist with reducing the costs associated with designing and implementing PV plant architectures by leveraging battery technologies (e.g., Li-Ion battery technologies, etc.), together with existing PV panel technologies, in a PV power plant. As a result, these embodiments can assist with reducing or eliminating at least some of the installation costs associated with centralized storage systems. Moreover, these embodiments can assist with reducing costs associated with hardware, software, or a combination of both, which can in turn assist with miniaturization and siliconization of the devices and systems used for PV power generation. The embodiments described herein can also assist with extending storage lifetime of PV power plants and with improving performance of PV power plants by customizing the charge/discharge profile of each battery in a dispatchable PV panel product that includes multiple types of voltage sources, which can in turn assist with improving predictability of available capacity of the PV power plant. In addition, the embodiments described herein can assist with providing information about each of the voltage sources in a dispatchable PV panel product that includes multiple types of voltage sources, which can in turn assist with optimization of resource usage and grid reliability. The embodiments described herein can also help with lowering the Levelized Cost of Energy (LCOE) of a PV power plant coupled with energy storage.

For an embodiment, a dispatchable photovoltaic (PV) panel product includes the following: (i) multiple types of voltage sources including a battery (e.g., a rechargeable lithium-ion battery, etc.) and a PV panel comprised of one or more PV cells; and (ii) a panel mounted inverter that includes at least one of a voltage source interface converter (VSIC) or a voltage source monitoring/protection system. For one embodiment, the voltage source monitoring/protection system is to monitor a condition of the battery. For one embodiment, the panel mounted inverter can also include a PV panel monitoring device to a condition of the PV panel. For one embodiment, the monitored condition of the battery can be converted into electronic data that is used to create a charge/discharge profile for the battery. The monitored condition of the PV panel can be used to create an accurate model of the PV panel that may be utilized to determine present and predict future panel capacity.

The monitored condition of the battery of the dispatchable PV panel product can include at least one of the following: (i) a yield of the battery, where the yield of the battery is a measure of energy derived from the power generated by the battery; (ii) a temperature characteristic of the battery; (iii) a voltage characteristic of the battery; or (iv) a current characteristic of the battery. The monitored condition of the PV panel of the dispatchable PV panel product can include at least one of the following: (i) a yield of the PV panel, where the yield of the PV panel is a measure of energy derived from the power generated by the PV panel; (ii) a temperature characteristic of the PV panel; (iii) a voltage characteristic of the PV panel; or (iv) a current characteristic of the PV panel.

For one embodiment, the voltage source monitoring/protection system is to protect the battery during a charging/discharging process, where the voltage source monitoring/protection system protects the battery from damage by detecting one or more potential hazardous situations associated with the battery and initiating a shutdown of at least one of the battery or the PV panel of the multiple types of voltage sources in response to the detection. For one embodiment, the VSIC is to perform voltage matching of the PV panel and the battery and to control the charging/discharging process of the battery using a preferred or desired charge/discharge profile. For one embodiment, an architecture of a photovoltaic (PV) power plant includes the dispatchable PV panel product.

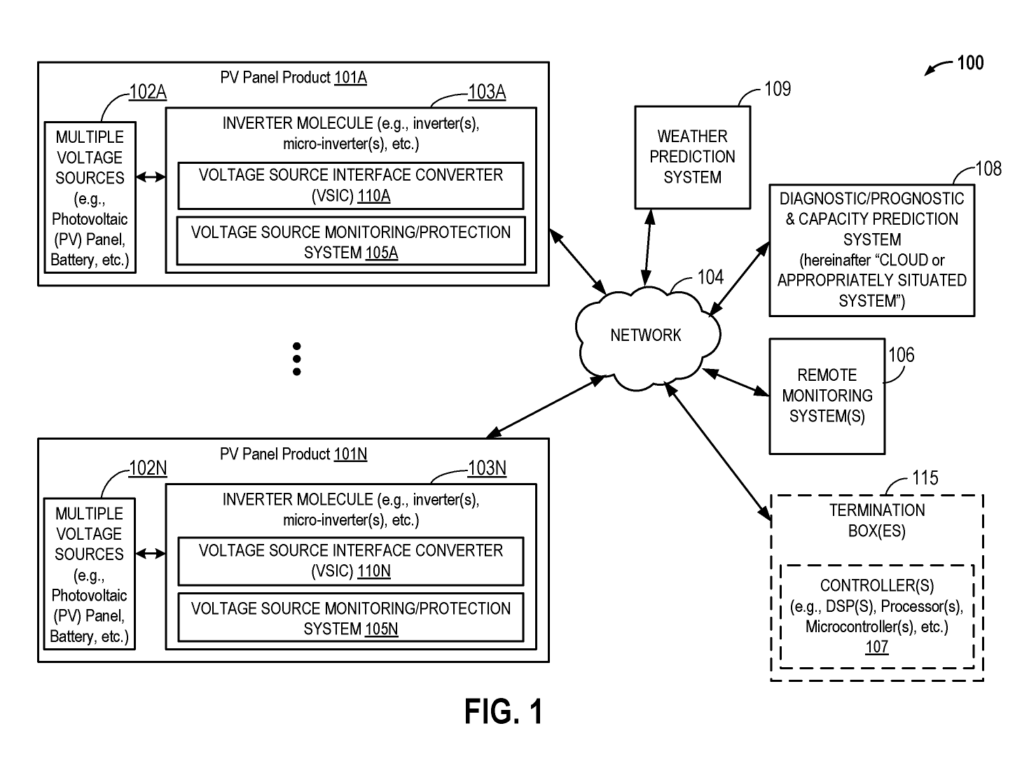

FIG. 1 is a block diagram of one embodiment of a system 100 that includes dispatchable PV panel products 101A-N, where each one of the PV panel products 101A-N includes multiple types of voltage sources 102A-N in accordance with an embodiment. It is to be appreciated that there are one or more PV panel products in system 100, where each of the PV panel products includes multiple voltage sources. For the sake of brevity, only PV panel product 101A will be described below in connection with FIG. 1.

As shown in FIG. 1, system 100 includes a PV panel product 101A, which includes multiple voltage sources 102A and an panel mounted inverter 103A. System 100 also includes a weather prediction system 109, a cloud or appropriately situated system 108, a remote monitoring system 106, and one or more optional termination boxes 115 that communicate with each other via network 104. Each of these elements of system 100 are described below.

Referring again to the PV panel product 101A, each of the multiple voltage sources 102A can be any device capable of generating direct current (DC) power, such as a battery consisting of two or more electrochemical cells that convert stored chemical energy into electrical energy or a PV panel comprised of one or more PV cells. For one embodiment, the multiple voltage sources 102A include at least the following: (i) a rechargeable battery or secondary cell (e.g., a rechargeable Li-Ion battery, etc.) that can be used for, among others, energy storage; and (ii) a PV panel comprised of one or more PV cells that can be used for, among others, energy generation.

As used herein, a “PV cell,” a “solar cell,” and their variations refer to an electrical device that converts the energy of light into electricity by a photovoltaic effect, which is a physical and chemical phenomenon. A PV cell is a form of a photoelectric cell, which is defined as a device whose electrical characteristics, such as current, voltage, or resistance, vary when exposed to light. PV cells are the building blocks of PV panels.

As used herein, a “battery,” a “rechargeable battery,” a “secondary cell,” and their variations refer to a type of electrical battery composed of one or more electrochemical cells (which are connected in parallel-connected, series-connected, or a combination of both) to obtain at least one of a required current capability or a required voltage capability. A battery can be charged, discharged into a load, and recharged many times. A battery can include at least one of the following: (i) a constant-voltage charger, which is a circuit that recharges a battery by sourcing only enough current to force the battery voltage to a fixed value; or (ii) a constant-current charger, which is a circuit that charges a battery by sourcing a fixed current into the battery, regardless of battery's voltage. A battery accumulates and stores energy through a reversible electrochemical reaction. A battery can be produced in many different shapes and sizes, ranging from button cells to megawatt systems connected to stabilize an electrical distribution network. A battery can be formed from several different combinations of electrode materials and electrolytes are used, including (but not limited to) lead-acid, nickel cadmium (NiCd), nickel metal hydride (NiMH), lithium ion (Li-ion), and lithium ion polymer (Li-ion polymer).

The PV panel product 101A also includes an panel mounted inverter 103A. For one embodiment, the panel mounted inverter 103A includes one or more inverters or micro-inverters, a voltage source monitoring/protection system 105A, and a voltage source interface converter (VSIC) 110A.

Each one of the multiple voltage sources 102A (e.g., a battery, a PV panel, etc.) is coupled to the panel mounted inverter 103A. For example, and for one embodiment, each of a battery and a PV panel that make up the multiple voltage sources 102A is electrically coupled to the molecule 103A. A combination of the multiple voltage sources 102A and the panel mounted inverter 103A that are coupled to each other forms a dispatchable PV panel product 101A. For one embodiment, the PV panel product 101A is used for acquiring or generating direct current (DC) energy from the multiple voltage sources 102A (e.g., a battery, a PV panel, etc.) and converting such energy into alternating current (AC) energy for many uses as is known in the art (e.g., electricity generation, charging of the battery, discharging the AC to an electrical load, etc.). It is to be appreciated that a PV panel product 101A can include multiple voltage sources 102A (e.g., a plurality of batteries, a plurality of PV panels, etc.) being coupled to the single panel mounted inverter 103A. Moreover, a plurality of PV panel products 101A can be connected to each other in a string configuration or an array configuration. For example, and for one embodiment, a plurality of PV panel products formed from PV panel products 101A-N are connected in a series connection to form a string. A PV power plant is comprised of a plurality of PV panel products 101A-N that are connected to each in at least one of a string configuration or an array configuration.

Network 104 can be at least one of a wired or wireless network. Network 104 can include at least one of an Ethernet-based network, a Wi-Fi-based network, a Bluetooth-based network, Zigbee-based network, Cellular Network, Radio Frequency Signal network, or any other type of suitable network that enables communication of data between the PV panel product 101A, the weather prediction system 109, the cloud or appropriately situated system 108, the remote monitoring system 106, and the optional termination box(es) 115. For one embodiment, each of the PV panel product 101A, the weather prediction system 109, the cloud or appropriately situated system 108, the remote monitoring system 106, and the termination box(es) 115 includes circuitry required for communication via network 104. For example, and for one embodiment, each of elements of system 100 includes at least one of a radio, a transmitter, or a transceiver for communicating data among each other via network 104. Each element of system 100 can also include a network interface (not shown), such as an Ethernet interface, universal bus interface, or Wi-Fi interface (such as IEEE 802.11, 802.11a, 802.11b, 802.16a, Bluetooth, Proxim's OpenAir, HomeRF, HiperLAN and others) that enables communication with the other elements of system 100 when network 104 is a wireless network.

For one embodiment, system 100 of FIG. 1 is configured to acquire battery data by hmeasuring or monitoring battery data from one or more batteries of the multiple voltage sources 102A. As used herein, “battery data” and its variations refer to measurable characteristics of a battery. Examples include, but are not limited to, the following: an actual yield of a battery (i.e., the actual energy derived from power generated by the battery); a current characteristic of a battery; a voltage characteristic of a battery; a temperature characteristic of a battery; an equivalent series resistance (ESR) of a cell of a battery, which is defined herein as an internal resistance present in the cell that limits the amount of peak current that the cell can deliver; a total ESR of a battery, which is defined herein as a sum of the ESRs of all cells of a battery; an Amp-hour capacity of a battery, which is defined herein as an amount of current that a battery can deliver for a predetermined unit of time (e.g., an hour, etc.) before the battery's voltage reaches the end-of-life point; a current rate or c-rate of a battery, which is defined herein as a current that is numerically equal to the Amp-hour capacity of the battery; a mid-point voltage (MPV), which is defined herein as a nominal voltage of the battery that is measured when the battery has discharged 50% of its total energy; a gravimetric energy density of a battery (which is defined herein as a measure of how much energy the battery contains in comparison to its weight); a volumetric energy density of a battery (which is defined herein as a measure of how much energy the battery contains in comparison to its volume); etc. For one embodiment, it is assumed that battery data is available from each battery that is part of the multiple voltage sources 102A. The battery data can be measured over a predetermined duration, e.g., on a daily basis, a bi-weekly basis, any other duration based on a unit of time, etc.

System 100 can use the acquired battery data to create a charge/discharge profile for one or more individual batteries of the multiple voltage sources 102A. As used herein, a “charge/discharge profile,” a “charge profile,” a “discharge profile,” and their variations refer to a function expressing voltage or current, or both, as a function at least of time (and, possibly, of other parameters, such as load or temperature or initial state of charge, for example) of a battery. A charge/discharge profile can be represented as a charge/discharge curve, as is known in the art. This is because the measured terminal voltage of a battery (V_{BATT}) and/or a current of the battery (I_{BATT}) varies as it is charged and discharged. For example, and for one embodiment, at least one of the V_{BATT} or the I_{BATT} is expressed as a function of at least one of operating temperatures, time, charge rate, or discharge rate, to show in a charge/discharge curve that at least one of a voltage generation capability of the battery or a current generation capability the battery varies with at least one of operating temperatures, time, charge rate, or discharge rate. As a specific example, such a charge/discharge curve can show that at normal operating temperatures the coulombic efficiency of the battery is very high, but at low temperatures there is a major drop in efficiency, particularly at high discharge rates (which can be used to indicate an abnormal functioning of the battery).

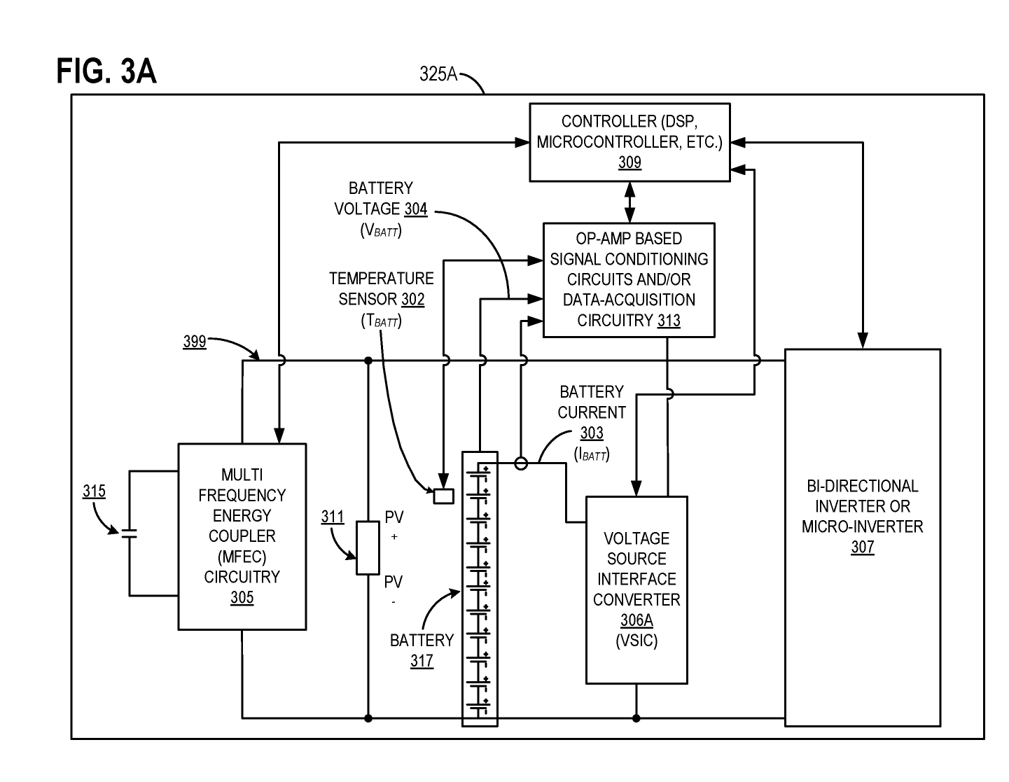

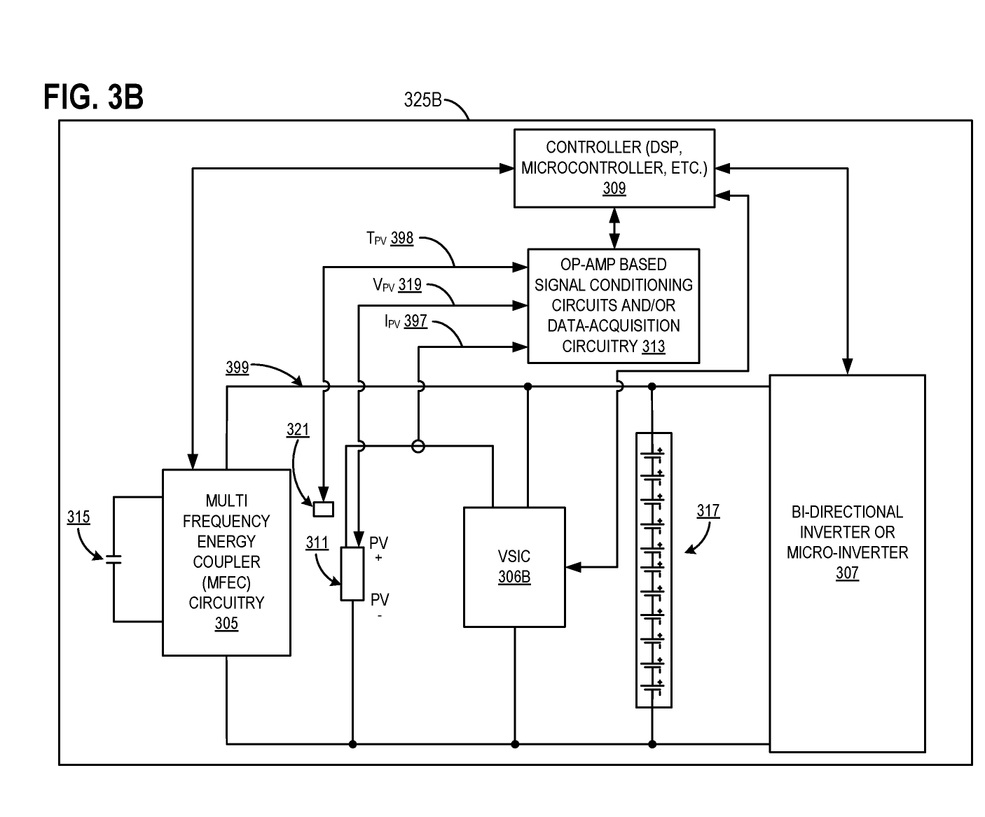

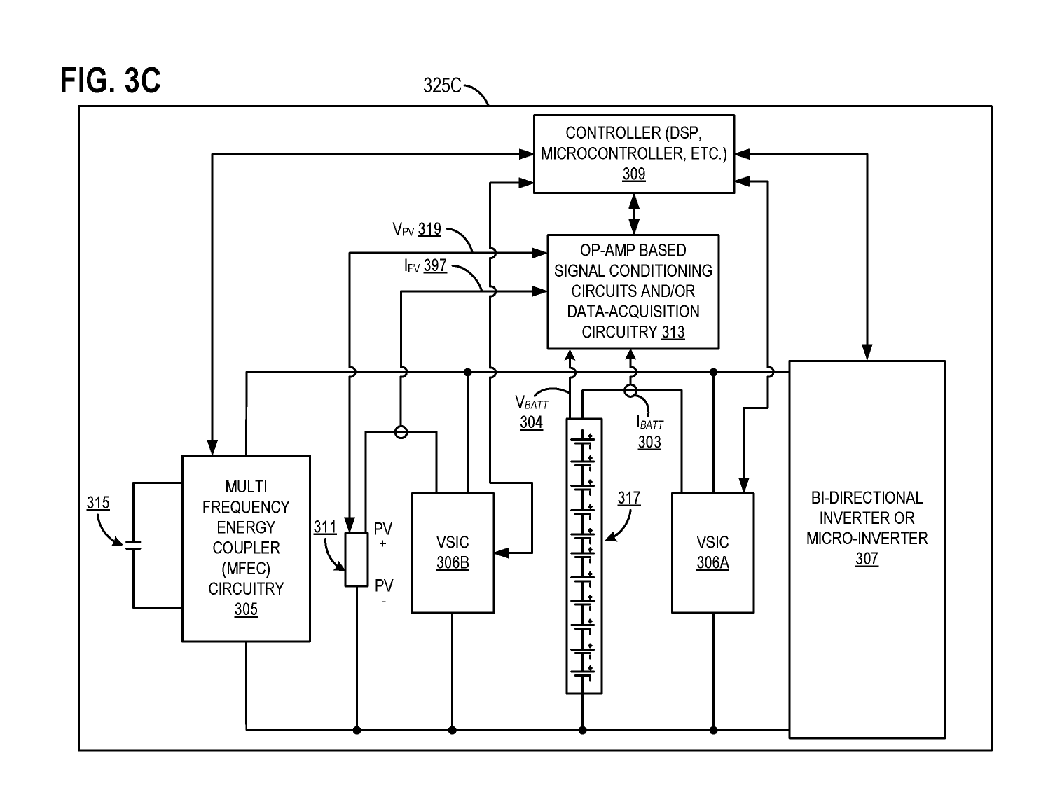

For one embodiment, the cloud or appropriately situated system 108 generates a charge/discharge profile for each battery of the multiple voltage sources 102A based on the acquired battery data. For a further embodiment, the cloud or appropriately situated system 108 aggregates the charge/discharge profiles of multiple batteries of the multiple voltage sources 102A and uses the aggregated data to generate a single charge/discharge profile for all of batteries of the multiple PV panels 102A. For one embodiment, the cloud or appropriately situated system 108 generates a degradation profile for each battery of the multiple voltage sources 102A based on the acquired battery data. For a further embodiment, the cloud or appropriately situated system 108 aggregates the acquired battery data of all batteries of the multiple voltage sources 102A and uses the aggregated data to generate a single degradation profile for all batteries of the multiple voltage sources 102A. Additional details about the charge/discharge profile and the degradation profile are provided below in connection with FIG. 3, 4, 5, or 6.

As explained above, the panel mounted inverter 103A includes one or more inverters or micro-inverters, a voltage source monitoring/protection system 105A, and a voltage source interface converter (VSIC) 110A. For one embodiment, the inverter(s) or micro-inverter(s) operate in a bi-directional manner to convert energy between AC and DC power, as needed, using energy obtained from the multiple voltage sources 102A. For one embodiment, the inverter(s) or micro-inverter(s) operate to convert energy between DC power obtained from the multiple voltage sources 102A into AC power that is discharged to at least one of an electrical load (e.g., an electrical grid, etc.) or a battery that is part of the multiple voltage sources 102A.

For one embodiment, the voltage source monitoring/protection system 105A is a system that includes one or more processors and/or sensors for performing the acquisition of battery data from the battery of the multiple voltage sources 102A. Each processor of the system 105A includes circuitry for this monitoring or measuring of battery data from the battery of the multiple voltage sources 102A. For one embodiment, each processor of the system 105A enables the monitoring or measuring of the battery data from the battery of the multiple voltage sources 102A to be performed in real-time or on-demand as may be needed. For this embodiment, each processor of the system 105A controls the monitoring or measuring of the battery data from the battery of the multiple voltage sources 102A. Circuitry of each processor of the voltage source monitoring/protection system 105A can include a number of execution units, logic circuits, and/or software used for measuring or monitoring the battery data from the battery of the multiple voltage sources 102A. For example, and for one embodiment, circuitry of a processor of a voltage source monitoring/protection system 105A that implements one or more functionalities described herein can be embodied in programmable or erasable/programmable devices, a field-programmable gate array (FPGA), a gate array or full-custom application-specific integrated circuit (ASIC), or the like. The functionalities of the processor can be performed using, for example, micro-code of a complex instruction set computer (CISC), firmware programmed into programmable or erasable/programmable devices, the configuration of an FPGA, the design of a gate array or full-custom ASIC, or the like. Additional details about the voltage source monitoring/protection system 105A is provided below in connection with at least FIGS. 3A-3C.

As explained above, the voltage source monitoring/protection system 105A can include at least one sensor that works with the processor(s) of the system 105A to monitor or measure battery data from the battery of the voltage sources 102A. As used herein, a “sensor” or its variations refer to an object, device, or system used for detecting events or changes in a specific operating environment, and then provide a corresponding output. For example, and for one embodiment, at least one sensor is used to monitor an operating environment of at least one of the multiple voltage sources 102A. Examples of a sensor include, but are not limited to, a pyranometer, a voltage sensor, a current sensor, a resistance sensor, a thermistor sensor, an electrostatic sensor, a frequency sensor, a temperature sensor, a heat sensor, a thermostat, a thermometer, a light sensor, a differential light sensor, an opacity sensor, a scattering light sensor, a diffractional sensor, a refraction sensor, a reflection sensor, a polarization sensor, a phase sensor, a florescence sensor, a phosphorescence sensor, an optical activity sensor, an optical sensor array, an imaging sensor, a micro mirror array, a pixel array, a micro pixel array, a rotation sensor, a velocity sensor, an accelerometer, an inclinometer, and a momentum sensor.

For one embodiment, at least one processor of the voltage source monitoring/protection system 105A is configured to protect the battery of the multiple voltage sources 102A from excessive degradation or damage, which may be caused during a charging or discharging of the battery. Examples of damage that can occur during a charging or discharging of the battery include, but are not limited to, cell reversal, damage to the battery attributable to the battery remaining in a discharged state over an extended period of time, abnormal behavior of the battery due to changing depth of discharge (DOD) over time, and degradation of the battery's capabilities over its useful lifespan. For one embodiment, the system 105A protects the battery of the sources 102A from damage by detecting one or more potential hazardous situations (e.g., an abnormal operating temperature, an abnormal discharge rate, an abnormal charging rate, etc.) associated with the battery of the multiple voltage sources 102A and initiating a shutdown of at least one of the battery or the PV panel of the multiple voltage sources 102A in response to the detection while allowing the others to keep operating. For one embodiment, the detected situations are based on the battery data acquired by the system 105A.

The VSIC 110A is, for one embodiment, a bidirectional circuit configured to perform voltage matching of the multiple voltage sources 102A (e.g., a PV panel and a battery). For one embodiment the VSIC 110A controls a charging/discharging of the battery of the multiple voltage sources 102A using the charging/discharging profile. For one embodiment, the VSIC 110A enables one of the multiple voltage sources 102A to provide power to another one of the multiple voltage sources 102A. For a first example, and for one embodiment, the VSIC 110A controls a charging of a battery of the multiple voltage sources 102A using power generated by a PV panel of the multiple voltage sources 102A. For a second example, and for one embodiment, the VSIC 110A controls a discharging of the battery of the multiple voltage sources 102A into a load (e.g., an electrical grid, etc.). For embodiments of the PV panel product 101A that include a PV panel as part of the multiple voltage sources 102A, the power generation capabilities and discharging capabilities of the PV panel are performed as is known in the art of PV power. To avoid obscuring the inventive concepts described herein, power generation capabilities and discharging capabilities of the PV panel will not be described in detail.

The VSIC 110A can be embodied as one or more processors. Circuitry of a processor of a VSIC 110A that implements one or more functionalities described herein can be embodied in programmable or erasable/programmable devices, a field-programmable gate array (FPGA), a gate array or full-custom application-specific integrated circuit (ASIC), or the like. The functionalities of the processor can be performed using, for example, micro-code of a complex instruction set computer (CISC), firmware programmed into programmable or erasable/programmable devices, the configuration of an FPGA, the design of a gate array or full-custom ASIC, or the like.

Monitored or measured battery data acquired by the voltage source monitoring/protection system 105A can be communicated, via network 104, to the cloud or appropriately situated system 108 of system 100. As used herein, a “cloud or appropriately situated system” and its variations refers to at least one computer or at least one data processing system comprising a user environment in which programs or materials are stored in one or more computers that can be accessed through a telecommunications network (e.g., a computer network, a data network, a local area network (LAN), a wide area network (WAN), the Internet, etc.) so that desired operations can be performed remotely using various terminals such as smartphones, laptop computers, desktop computers, and other computing systems as is known in the art.

The cloud or appropriately situated system 108 can be resident in a PV power plant (not shown). For this embodiment, the cloud or appropriately situated system 108 receives one or more commands that cause the system 108 to perform one or more grid functionalities, including performing energy arbitrage among different pre-defined regions, supply shifting, photovoltaic power smoothing (PV smoothing), or low voltage ride-through. For one embodiment, grid functionalities are categorized into three main groups: (1) frequency-watt grid functionality, which refers to compensation of frequency variations outside of operating limits by increasing or decreasing real power—e.g., frequency regulation of the grid network, etc.; (2) volt-watt grid functionality, which refers to adjustment of a grid voltage by injecting increased or decreased real power at the point of common coupling—e.g., low voltage ride-through, etc.; and (3) volt-VAR grid functionality, which refers to adjustments of a grid voltage by injecting increased or decreased reactive power at the point of common coupling—e.g., power factor correction, VAR compensation, etc.

Energy storage in batteries may assist with meeting the requirements of frequency-watt and volt-watt grid functionalities, both of which necessitate real power, thereby, real energy storage. For frequency-watt and volt-watt functions, each of the dispatchable PV products 101A-N can supply in-phase or active currents to counter an impact of the grid frequency and voltage variations due to excessive real power draw by active loads.

Capacitor-based energy storage devices or energy storage devices with high power handling capability (e.g., energy storage devices in batteries that behave like capacitors, etc.) may assist with meeting the requirements of volt-VAR grid functionality. In particular, capacitor-based energy storage can help with instantaneous adjustments of reactive power necessary for short-duration voltage fluctuations resulting from low power factor loads drawing excessive out-of-phase or reactive currents from the grid feeder system. For volt-VAR grid functionality, each of the dispatchable PV products 101A-N can supply counteracting out-of-phase or reactive currents to negate the impact of the low power factor loads.

For one embodiment, the system 108 performs energy arbitrage by obtaining energy supply data from the PV panel products 101A-N to determine a total available power for a certain duration to be supplied to a feeder on a grid network. In this way, the system 108 can implement energy arbitrage by offering an available capacity or energy to the grid network based on real-time capacity and energy pricing information. The available capacity can be determined because the panel level inverter 103A allows at least some of the solar power obtained by the PV panel of the voltage sources 102A to flow into the battery of the voltage sources 102A for use at a preferred time while allowing any excess to be routed into an electrical load (e.g., the grid network, etc.).

Furthermore, the system 108 can perform supply shifting. For one embodiment, the system 108 performs supply shifting by performing, based on the acquired energy supply data from the products 101A-N, at least one of: (i) offering to sell capacity and/or energy on a pre-defined or dynamically allocated time-period based on market opportunities; or (ii) offering to purchase energy from the grid network if total generated energy exceeds the total power consumed on the feeder and as determined by the grid operator.

Furthermore, the system 108 can perform photovoltaic power smoothing (PV smoothing). PV smoothing involves the system 108 preventing rapid, undesirable voltage fluctuations as solar input to a PV panel of the voltage sources 102A varies or vanishes completely. The inverter molecule 103A can enable energy that is stored in the battery of the voltage sources 102A to supplement or substitute the PV energy generated by the PV panel of the voltage sources 102A as solar input to the PV panel varies or vanishes completely. For a further embodiment, the cloud or appropriately situated system 108 that is part of the PV power plant may communicate with one or more optional termination boxes 115 (as described below) utilizing the telecommunications network 104 (as described above). For these embodiments, the PV power plant is comprised of one or more PV panel products 101A, where each PV panel product 101A includes multiple types of voltage sources 102A and at least one panel mounted inverter 103A.

For one embodiment, the panel mounted inverter 103A communicates the acquired battery data to at least one optional termination box 115, which then communicates the acquired battery data to the cloud or appropriately situated system 108. In one embodiment, the one or more optional termination boxes 115 include at least one overall controller 107 for coordinating the overall monitoring or measuring of the data from each of the PV panels 102A-N. For one embodiment, the overall controller 107 enables the monitoring or measuring of the battery data from each battery of the multiple voltage sources 102A to be performed in real-time or on-demand as may be needed. For this embodiment, the controller 107 communicates with the panel mounted inverter 103A to coordinate the monitoring or measuring of the battery data from the multiple voltage sources 102A. Circuitry of the controller(s) 107 of the termination box 115 can be similar to or the same as the processor(s) of the monitoring devices 105A, which are described above. For another embodiment, the one or more terminal boxes 115 are optional. For this embodiment, the panel mounted inverter 103A communicates the acquired battery data directly to the cloud or appropriately situated system 108 via network 104. Thus, in at least one embodiment of system 100, the termination box 115 is not necessary.

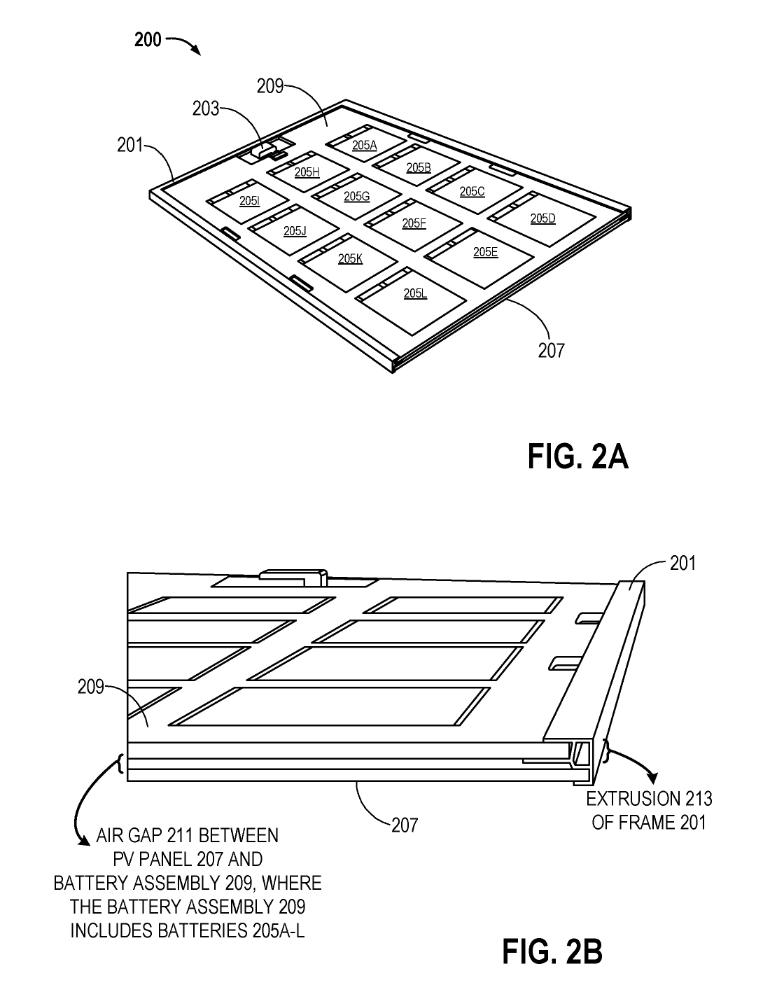

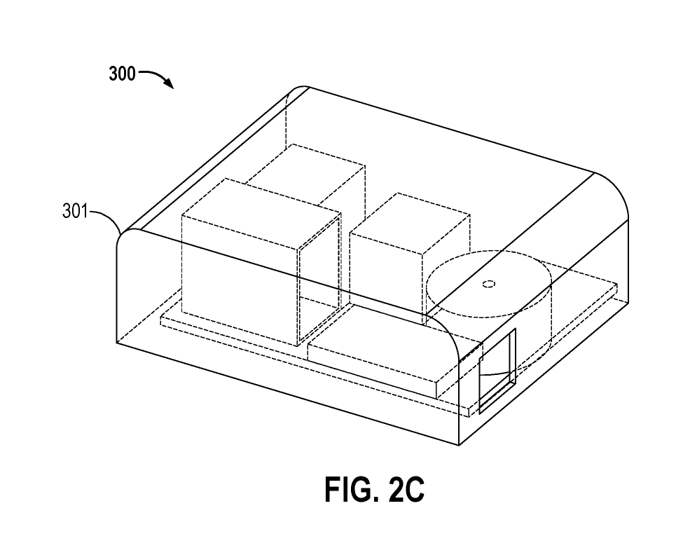

For one embodiment, the cloud or appropriately situated system 108 processes the received battery data to generate a charge/discharge profile for a respective battery of multiple voltage sources 102A. Additional details about a charge/discharge profile are discussed below in connection with at least one of FIGS. 2-5. After the battery data has been processed, the cloud or appropriately situated system 108 can update a charge/discharge profile of each battery that is part of the voltage sources 102A. For example, a charge/discharge profile is updated using at least one of a parameter-identification algorithm or a learning algorithm, as is known in the art. For a further example, algorithms based on non-linear regression analysis, algorithms based on other forms of regression analysis known in the art, or algorithms based on Bayesian techniques can be performed on an existing charge/discharge profile to update a battery's charge/discharge profile.

For one embodiment, the voltage source monitoring/protection system 105A is further configured to acquire PV panel data from the PV panel of the voltage sources 102A. As used herein, “PV panel data and its variations refer to measurable characteristics of a PV panel. Examples include, but are not limited to, an actual yield of a PV panel (i.e., the actual energy derived from power generated by the PV panel) a current characteristic of a PV panel, a voltage characteristic of a PV panel, a temperature characteristic of a PV panel, etc.). The acquired PV panel data can be used by the system 108 to generate a dynamically updated panel model for the PV panel of the voltage sources 102A. PV panel data and a dynamically updated panel model for a PV panel are described in detail in the International patent application no. PCT/US2015/57907, filed Oct. 28, 2015, entitled SYSTEMS AND METHODS FOR DISPATCHING MAXIMUM AVAILABLE CAPACITY FOR PHOTOVOLTAIC POWER PLANTS, which is hereby incorporated in its entirety by reference.

For an embodiment, a weather prediction system 109 communicates weather data to the cloud or appropriately situated system 108. As used herein, a “weather prediction system,” a “weather system,” and their variations refer to at least one computer or at least one data processing system that includes weather data indicative of weather from different sources for different sets of weather data locations. The weather prediction system 109 can include one or more processors that estimate or derive weather observations/conditions for any given location using observed weather conditions from neighboring locations, radar data, lightning data, satellite imagery and other techniques known in the art. For an embodiment, the durational window can be at least one of a minutes-ahead window, an hours-ahead window, a days-ahead window, or any other window specifying a predetermined duration.

For one embodiment, the cloud or appropriately situated system 108 combines the weather data of the system 109 with the dynamically updated panel model to compute predictions of the performance capabilities or characteristics of the PV panel of the voltage sources 102A. For one embodiment, the cloud or appropriately situated system 108 uses the weather data of the system 109, the charge/discharge profile of the battery of the voltage sources 102A, and the dynamically updated panel model of the PV panel of the voltage sources 102A to predict when the battery can be used instead of the PV panel to provide energy or power to a load. For one embodiment, the cloud or appropriately situated system 108 uses the weather data of the system 109, the charge/discharge profile of the battery of the voltage sources 102A, and the dynamically updated panel model of the PV panel of the voltage sources 102A to predict when the battery can be charged by the PV panel.

For example, and for one embodiment, the weather data, the charge/discharge profile, and the dynamically updated PV panel model is used to compute the following: (i) a future yield of the PV panel (i.e., a future energy derived from power to be generated by the PV panel of voltage sources 102A for a specified durational window); and (ii) a future yield of the battery (i.e., a future energy derived from power to be generated by the battery of voltage sources 102A for a specified durational window). Based on these two future yields, the cloud or appropriately situated system 108 can direct (i) the battery of the voltage sources 102A to discharge power to a load (e.g., an electrical grid, etc.); (ii) the PV panel of the voltage sources 102A to discharge power to a load (e.g., an electrical grid, etc.); or (iii) the PV panel of the voltage sources 102A to charge the battery of the voltage sources 102A. In this way, the predictability of power generated by a PV power plant that includes one or more PV power products 101A can be improved.

For one embodiment, each future yield of the voltage sources 102A is a key performance indicator (KPI). As used herein, a “key performance indicator (KPI)” and its variations refer to an ideal performance characteristic or parameter of one of the multiple voltage sources 102A (e.g., the battery of the voltage sources 102A, the PV panel of the voltage sources 102A, etc.). For a first example, and for one embodiment, a KPI can be a future yield of the PV panel of the voltage sources 102A that is determined using the PV panel data. For a second example, and for one embodiment, a KPI can be a future yield of the battery of the voltage sources 102A that is determined using the battery data.

Examples of a KPI that can be used for a battery of the voltage sources 102A include, but are not limited to, a future current generated by a battery of the voltage sources 102A, a future voltage generated by a battery of the voltage sources 102A, a future yield of a battery of the voltage sources 102A, a predicted maximum power of a battery of the voltage sources 102A, a predicted voltage at a predicted maximum power of a battery of the voltage sources 102A, a predicted current at a predicted maximum power (also known as peak current) of a battery of the voltage sources 102A, a self-discharging rate of a battery of the voltage sources 102A (which is based on the operating temperature of the battery), a recharge time of a battery of the voltage sources 102A (i.e., a time until the batter is fully charged), a charging current of a battery of the voltage sources 102A that can be safely applied to the battery indefinitely without any kind of monitoring or charge termination method,), a predicted maximum operating temperature of a battery of the voltage sources 102A that can be safely applied to the battery indefinitely without reducing at least one of a known maximum charging current or a known maximum charging voltage of the battery.

Examples of a KPI that can be used for a PV panel of the voltage sources 102A include, but are not limited to, a future current generated by a PV panel of the voltage sources 102A, a future voltage generated by a PV panel of the voltage sources 102A, a future yield of a PV panel of the voltage sources 102A, a future short circuit current of a PV panel of the voltage sources 102A, a future open circuit voltage of a PV panel of the voltage sources 102A, a predicted maximum power of a PV panel of the voltage sources 102A, a predicted voltage at a predicted maximum power of a PV panel of the voltage sources 102A, and a predicted current at a predicted maximum power of a PV panel of the voltage sources 102A.

For one embodiment, a KPI is determined using one or more algorithms. Such algorithms for generating KPIs include, but are not limited to, algorithms based on regression analysis and algorithms based on Bayesian techniques.

System 100 also provides a non-limiting example of a cloud or appropriately situated system 108 that combines weather data received from the weather prediction system 109 with battery data and PV panel data for computing predicted capacity availability based on the PV and energy storage of the voltage sources. For a further embodiment, the cloud or appropriately situated system 108 aggregates the acquired battery data and PV panel data from all of the individual PV panel products 101A-N of a PV power plant, and generates a set of predictions for the PV power plant. For yet another embodiment, the generated set of predictions for the PV power plant is based on the weather data acquired from the weather prediction system 109. The cloud or appropriately situated system 108 can communicate the set of predictions to appropriate authorities (e.g., electric utilities, ISOs, etc.) as needed to control the dispatch of the PV power plant on the grid.

For an embodiment, the acquired battery data and PV panel data can also be used to perform at least one of fault detection, diagnosis, or prognosis. Here, algorithms having appropriate aging models predict when an individual battery or an individual panel will reach a specific level of performance degradation. Algorithms for predicting degradation rates of batteries and PV panels are well known, and as a result, these algorithms are not discussed in detail. Algorithms for predicting a degradation rate of a battery or a PV panel can include, but are not limited to, algorithms based on regression analysis and algorithms based on Bayesian techniques.

For a further embodiment, the charge/discharge profile of each battery of the voltage sources 102A and the dynamically updated PV panel model for each PV panel of the voltage sources 102A are aggregated to predict when the entire PV power plant will reach a specific performance degradation. System 100, therefore, also provides a non-limiting example of using battery data and PV panel data to determine a time until an individual battery, an individual panel, or an entire plant reaches a minimum performance threshold. Additionally, the granular information and degradation predictions can provide ancillary services such as improved voltage regulation, improved control of the charging/discharging of the batteries of the voltage sources 102A.

System 100 also includes a remote monitoring system 106. As used herein, a “remote monitoring system” and its variations refer to at least one computer or at least one data processing system that communicates with at least one of the cloud or appropriately situated system 108, the panel mounted inverter(s) 103A-N, or the termination box 115 (if available) to analyze the charge/discharge profiles and the PV panel models for at least one of monitoring the generated predictions, monitoring the charge/discharge profile and the PV panel models, and detecting or diagnosing issues of one or more of the PV panel products 101A. The remote monitoring computer or system 106 communicates via network 104. For one embodiment, the remote monitoring computer or system 106 is associated with a third party—for example, an electric utilities company, an ISO, etc.—that uses the predictions, the charge/discharge profiles of the batteries, and the PV panel models of the PV panels as needed to control or adjust dispatching of a PV power plant's generation resources. For yet another embodiment, the knowledge of the PV plant capacity may allow the third party to dispatch other generating resources to balance the requirements of the load on the grid. For example, and for one embodiment, a plant dispatcher (e.g., an electrical utilities company or an ISO) can use the knowledge of the PV plant capacity (i.e., the predictions and the PV panel models) of an entire PV power plant that is produced by the system 100 to assist with reducing or eliminating the use of capital-intensive spinning reserves as backups for the PV power plant.

For one embodiment, the remote monitoring computer or system 106 works together with the cloud or appropriately situated system 108 to perform at least one of energy arbitrage, supply shifting, PV smoothing or low voltage ride-through as described above. For one embodiment, information associated with at least one of energy arbitrage, supply shifting, or PV smoothing is communicated between the system 108 and an electrical utilities company or an ISO (or any other appropriate third party) via the remote monitoring computer or system 106.

FIG. 2A is a pictorial illustration of a dispatchable PV panel product 200, or an all-in-one product which includes multiple types of voltage sources in accordance with an embodiment and the entire power conversion including the VSIC and the inverter. The PV panel product 200 of FIG. 2 can be included in the system 100, which is described above in connection FIG. 1.

As explained above, and for one embodiment, a dispatchable PV panel product 200 is an all-in-one product formed from a combination of multiple types of voltage sources (e.g., a PV panel 207 and battery assembly 209 comprised of batteries 205A-L, etc.) and at least one panel mounted inverter (e.g., the panel mounted inverter 203) that are coupled to each other. In the illustrated embodiment shown in FIG. 2A, the dispatchable PV panel product 200 includes the PV panel 207 (not shown) housed in a frame 201, a panel level inverter 203, and a battery assembly 209 comprised of multiple batteries 205A-L. The dispatchable PV panel product 200 can also include one or more connectors (not shown) for coupling or connecting the dispatchable PV panel product 200 to a termination box (not shown), an electrical grid (not shown), another PV panel product (not shown), or an electrical load as is known in the art. The connector(s) can be a wired connector(s) as is known in the art. The panel mounted inverter 203 is similar to or the same as the panel mounted inverter 103A described above in connection with FIG. 1. Furthermore, the battery assembly 209 comprised of multiple batteries 205A-L and the PV panel 207 are similar to or the same as the multiple voltage sources 102A described above in connection with FIG. 1. The PV panel 207 (not shown) is housed in a frame 201. For one embodiment, the frame 201 is made from at least one of metal, plastic, or any suitable materials known in the art. The multiple batteries 205A-L housed in a battery assembly 209. For one embodiment, the battery assembly 209 is made from at least one of metal, plastic, or any suitable materials known in the art. It is to be appreciated that the dispatchable PV panel product 200 can include at least one PV panel 207 and at least one of the multiple batteries 205A-L.

FIG. 2B is a close-up view of the pictorial illustration of the dispatchable PV panel product 200 shown in FIG. 2A. As shown in FIG. 2B, and for one embodiment, an extrusion 213 of the frame 201 used for the PV panel 207 (facing downwards) provides a groove for mounting/housing the battery assembly 209 comprised of multiple batteries 205A-L. For one embodiment, an air gap 211 between the PV panel 207 and the battery assembly 209 provides thermal isolation between the PV panel 207 and the multiple batteries 205A-L housed in the battery assembly 209. For one embodiment, the dispatchable PV panel product 200 has a maximum PV power value of 300 W. For one embodiment, the dispatchable PV panel product 200 is replaced once every 25 years. For one embodiment, the following table 1 provides the specifications of the dispatchable PV panel product 200.

TABLE 1
Specification of dispatchable PV panel product 200:

| Parameter | Value | |
|---|---|---|
| Max PV Power @STC | 300 | Wp |
| PV Cells per Module | 60 | |
| Batt Cells per Module | 12 | |
| Batt Cell Capacity (0.3 C) | 32.5 | Ah |
| Batt Cell Size | 124 | Wh |
| Nominal Batt Cell Voltage | 3.75 | V |
| Battery Pack Size | 1488 | Wh |
| Nominal Pack Voltage | 22.5 | V |
| Module Weight | 58 | lbs |

| | |
|---|---|
| Op. Temp Range | −30 to 60 C. |
| | derated above 52 C. |
| Min. Round Trip Eff. (EOL) | 90% |
| Lifetime 100% DoD cycles | >12,000 |
| Lifetime PV smoothing cycles | >35,000 |
| (upto 50% PV capacity) | |

For one embodiment, the multiple batteries 205A-L are housed in the battery assembly 209 to assist with controlling thermal issues that stem from an uncontrolled ambient environment that the product 200 is placed in. For one embodiment, the air gap 211 and the extrusion 213 enable the multiple batteries 205A-L housed in the battery assembly 209 to be detachable from the product 200. In this way, the multiple batteries 205A-L housed in the battery assembly 209 can be designed to be field-serviceable. For one embodiment, various dissipation mechanisms including cost-effective package integrated heat-pipes can be used to assist the reduction of the negative effects of these thermal issues. For one embodiment, the product 200 includes the panel level inverter 203, which, in addition to converting DC energy to grid quality AC, is designed to monitor the temperature of one or more of the multiple batteries 205A-L housed in the battery assembly 209; track energy profile of the PV panel 207 and one or more of the multiple batteries 205A-L housed in the battery assembly 209; optimize charge and discharge balancing of one or more of the multiple batteries 205A-L housed in the battery assembly 209; maximize the PV panel 207 generation and actively diagnose one or more of the multiple batteries 205A-L housed in the battery assembly 209 for potential hazardous conditions.

FIG. 2C is a pictorial illustration of a panel level inverter 300 in accordance with an embodiment. The panel level inverter 300 can be included in the PV panel product 101A-N described above in connection with FIG. 1 or the PV panel product 200 described above in connection with FIGS. 2A-2B. The panel level inverter 300 is similar to or the same as the panel level inverters 103A-N or 203 described above in connection with FIGS. 1 and 2A-2B. The panel level inverter 300 includes several components that are encased in a housing 301. For one embodiment, the components encased in the housing 301 include the VSIC 110A and the voltage source monitoring/protection system 105A, which are described above in connection with FIG. 1. For one embodiment, the components encased in the housing 301 are described below in connection with at least one of FIG. 3, 4, 5, 6, or 7. For one embodiment, the panel level inverter 300 has an approximate height between 1 inches and 2 inches, an approximate width between 2 inches and 2.5 inches, and an approximate length between by 3 inches and 3.5 inches.

FIG. 3A is a block diagram illustration of a dispatchable PV panel product 325A, which includes multiple types of voltage sources 311 and 317 in accordance with an embodiment. The dispatchable PV panel product 325A of FIG. 3A provides additional details about the dispatchable PV panel product of FIGS. 2A-2C.

The PV panel product 325A can include at least one of a PV panel 311, a battery 317, a voltage source interface converter (VSIC) 306A, a bi-directional panel level inverter or micro-inverter 307, data-acquisition circuitry 313, Op-Amp based signal conditioning circuitry 313, a battery temperature sensor 302, a controller 309, a multi-frequency energy coupler (MFEC) 305, a capacitor 315, or a low-pass filter (not shown). The low-pass filter (not shown) can be used to couple the dispatchable PV panel product to a load (e.g., an electrical grid, etc.). For some embodiments, these recited components of the PV panel product 325 (except for the PV panel 311 and the battery 317) can be provided in, for example, any of the panel level inverter as described above with respect to FIGS. 1-2C. As shown in the illustrated embodiment of the PV panel product 325A set forth in FIG. 3A, the battery 317 is comprised of multiple cells. The battery 317, however, is not so limited—i.e., the battery 317 can comprise at least one cell.

Multiple voltage sources (e.g., the PV panel 311 and the battery 317, etc.) can be coupled to the bi-directional panel level inverter or micro-inverter 307 (hereinafter “bi-directional inverter 307”). The bi-directional inverter 307 can also include a boost/buck circuit and/or a DC-to-AC H-bridge inverter (as part of bi-directional inverter 307 in FIG. 3A). As a result of exposure from sunlight, for example, a PV panel 311 can provide a DC output to the bi-directional inverter 307. The combination of PV panel 302 and bi-directional inverter 307 enables the PV panel product 325 to act as an all-in-one solar PV energy collection, storage and conversion system. Moreover, the battery 317 can provide a DC output to the bi-directional inverter 307 connected through the VSIC 306A. The combination of battery 317 and bi-directional inverter 307 enables the PV panel product 325 to act as an excess energy storage and backup energy generation that supplements the solar PV energy collection and conversion system. In this way, the PV panel product 325A is an all-in-one package that acts as (i) a solar PV energy collection, storage and conversion system; and (ii) an excess energy storage and backup energy generation that supplements the solar PV energy collection and conversion system.

As shown in FIG. 3A, the VSIC 306A is connected, via the DC bus 399, to the PV panel 311. For one embodiment, the PV panel 311 charges the battery 317 via the VSIC 306A if all of the energy generated by the PV panel 311 is not routed to an electrical load (e.g., an AC grid, etc.). For one embodiment, all DC power is routed to the panel level inverter for delivery to an electrical load (e.g., an AC grid, etc.). The VSIC 306A can also be referred to as a battery interface converter.

The bi-directional inverter 307 serves, on one side, to convert a direct current (DC) voltage from the battery 317 or the PV panel 311 into an alternating current (AC) voltage that can be discharged to a load (e.g., an electrical grid, etc.). The bi-directional inverter 307 also serves to charge the battery 317 from a combination of the AC voltage or from the PV voltage obtained directly from the PV panel 302. Thus, the energy flows both from the battery 317 to a DC-AC converter of the bi-directional inverter 307 and from the DC-AC converter of bi-directional inverter 307 to the battery 317. The bi-directional inverter 307 can, for one embodiment, include any components required for bi-directional conversion of power known in the art.

For one embodiment, the bi-directional inverter 307 can be in communication with a controller 309. One or more electrical signals can pass between the bi-directional inverter 307 and the controller 309. The electrical signals can include command information that can be exchanged for controlling the bi-directional inverter 307 (and in turn, PV panel 311 or the battery 317). For example, the commands can control one or more parameters relating to converting a DC voltage to an AC voltage, and vice versa. Such parameters can include the voltage that the bi-directional inverter 307 can operate at, and/or the current amounts that the bi-directional inverter 307 can operate at. For some embodiments, monitoring information can be passed from the bi-directional inverter 307 to the controller 309. Such monitoring information may provide feedback to the controller 309 in order to better maintain or alter the commands provided to the bi-directional inverter 307. Thus, in each PV panel product 325, depending on different implementations, a one-way communication can be provided from the controller 309 to the bi-directional inverter 307, a one-way communication can be provided from the bi-directional inverter 307 to the controller 309, or two-way communications can be provided between the controller 309 and the bi-directional inverter 307.

The controller 309 can also communicate with other controllers 309 or control blocks (not shown) of other dispatchable PV panel products 325 (not shown). For some embodiments, the controller 309 can receive instructions from an overall processor—for example, a processor 107 of the termination box 104 described above in connection with FIG. 1. For these embodiments, the controller 309 can permit synchronized current generation among a plurality of PV panel products 325. For some other embodiments, the controller 309 can be dynamically delegated as being a master controller 309 of a plurality of PV panel products 325, while the other controllers 309 of the other PV panel products 325 within a string are configured to be slave controllers. Each controller 309 can also be capable of adjusting the power output of its respective PV panel product 325 at its maximum power point or an improved power point.

The bi-directional inverter 307 can also communicate with a multi-frequency energy coupler (MFEC) circuit 305. For one embodiment, the illustrated MFEC circuitry 305 serves the function of balancing the AC and DC instantaneous power between the input (DC) and output (DC) power generated by or provided to at least one of the battery 317 or the PV panel 311. At least one embodiment of the MFEC circuitry 305 is described in detail in U.S. patent application Ser. No. 13/546,868, filed Jul. 11, 2012, entitled SYSTEMS AND METHODS FOR SOLAR PHOTOVOLTAIC ENERGY COLLECTION AND CONVERSION, which is hereby incorporated in its entirety by reference. At least one other embodiment of the MFEC circuitry 305 is described in detail in International patent application no. PCT/US2015/57907, filed Oct. 28, 2015.

For example, in order to meet the requirements of the double frequency (120 Hz) power on an electrical grid when the PV panel 302 and/or the battery 317 is generating power, the MFEC circuitry 305 acts as a cycle-by-cycle energy storage that provides power balancing between the DC power (from the PV panel 302 or the battery 317) and single-phase AC power (to be outputted by the PV panel product 325 or battery 317) every electrical cycle. For one embodiment, the MFEC circuitry 305 allows for a low cost means for cycle-by-cycle necessary energy storage. In one scenario, the PV panel product 325 of FIG. 3 can be based on low voltage circuits and components, and if a presently available energy storage device used for power balancing is placed on the low voltage bus, then a capacitor with a high capacitance is required. Such a capacitor, in one example, if constructed with film material, can be prohibitively expensive or, if made with electrolytic components, may be insufficiently reliable. The MFEC circuitry 305 can be used to both avoid use of expensive and unreliable capacitors because the MFEC circuitry 305 stores the required energy at a relatively higher voltage requiring less capacitance thus, allowing economical usage of highly reliable capacitors. Specifically, because energy stored in a capacitor is proportional to the square of the voltage of the capacitor, increasing the voltage of the energy storage (i.e., the MFEC circuitry 305) can reduce the capacitance requirement of the passive element (i.e., the capacitor). In order to reduce the required capacitance, the MFEC circuitry 305 includes a higher voltage bus that allows for a capacitor of a lower capacitance.

For one embodiment, an electrical grid (not shown) can demand AC power that is lower than the AC power converted from the DC power that is obtained from the PV panel 302 and/or the battery 317. In such situations, energy can be stored by using the MFEC circuitry 305. Alternatively, in cases where the grid demand is higher than the power obtained from the PV panel 302 and/or the battery 317 (which is then converted by the PV panel product 325), energy can be used from the MFEC circuitry 305. Thus, for at least one embodiment, the MFEC circuitry 305 can handle and/or accommodate the DC energy supplied by the PV panel 302 and/or the battery 317 (which is then converted by the dispatchable PV panel product 325) for delivery to an electrical grid. Because the WEE circuitry 305 can permit increased voltage, which can result in reduced capacitance, high-reliability film capacitors (e.g., the film capacitor 315, etc.) can be used for cycle-by-cycle energy storage. These film capacitor (e.g., the film capacitor 315, etc.) can provide advantages over electrolytic energy storage configurations. For alternate embodiments, electrolytic energy storage can also be used in combination with or in place of the high-reliability capacitors (e.g., the film capacitor 315, etc.). These alternate embodiments can enable the WEE circuitry 305 to provide increased grid stability functionalities such as, reactive power compensation, power factor correction, voltage sag ride through and/or other similar grid disturbance prevention that are being gradually mandated by electrical utilities companies or ISOs.

For some embodiments, command/communication signals can also be exchanged between the MFEC circuitry 305 and the bi-directional inverter 307. These communications can be a two-way communication, or one-way communication/commands from the bi-directional inverter 307 to the WEE circuitry 305, or vice versa. For other embodiments, the MFEC circuitry 305 can directly receive control signals from the controller 309. Using the command signals, the MFEC circuitry 305 can be configured to handle 120 Hz power that is demanded by a grid current while maintaining DC power delivery operation of the PV panel 302 and generating 60 Hz current for the 60 Hz voltage on an electrical grid. In one embodiment, the MFEC circuitry 305 can be capable of handling any frequency power demanded by a grid current while generating another frequency or the same frequency current for the voltage on an electrical grid. In some instances, the output frequency power to an electrical grid may be the same as, double, triple, or any multiple of the frequency current for the voltage on the electrical grid. The MFEC circuitry 305 can also adjust the power output of the PV panel product 325 at its maximum power point or an improved power point.

For some embodiments, the LPF (not shown) can provide a current to be outputted from the PV panel product 325 and can provide an alternating current from which high frequencies have been attenuated or removed (e.g., the LPF can process or modify the current that is outputted from the bi-directional inverter 307). Currents outputted from the PV panel product 325 can be provided to a load center or an electrical grid. In some instances, the outputted current can pass through the LPF (not shown) and/or other types of filters before reaching the load center or the electrical grid.

For some embodiments, the one or more components of the PV panel product 325 can include both high-voltage (HV) and low-voltage (LV) components. The HV component can comprise a metal-oxide-semiconductor field effect transistor (MOSFET) and/or insulated gate bipolar transistor (IGBT) with an anti-parallel ultrafast diode, while the LV component can comprise a MOSFET and/or Schottky diode combination. Depending on implementations, there can be advantages for using MOSFETs. For example, MOSFETs may permit the reverse flow of current, can be more efficient than IGBTs, and/or can permit faster switching than IGBTs. The use of MOSFETs can be permitted by the low voltages used in the PV panel product 325. Additionally, to further improve the efficiency of conversion, gate drive energy recovery circuits can be employed for the power switches. This gating energy is typically dissipated in conventional IGBT-based centralized inverters and micro-inverters due to the difficulty (because larger passive components are required) in designing such circuits around slower switching speed semiconductor switches. MOSFET-based implementation of the PV panel product 325 can also benefit from the utilization of two different types of MOSFETs—one that is optimized for higher switching speeds, and the other that is optimized for low conduction drop. For example, the former type of MOSFET can allow the implementation of the high switching frequency pulse width modulation, while the latter type of MOSFET can allow grid frequency commutation provided at a low conduction drop for the reversal in direction of the grid AC currents.

For one embodiment, using two different types of MOSFETS (one that is optimized for high switching speeds and another that is optimized for low switching speeds) in one or more of the components of the PV panel product 325 allows for lower commutation losses and the synthesis of purely sinusoidal AC waveforms allows AC voltage summation with minimal bandwidth controller communications and no central processing for voltage generation, current control and load/grid interface. This can enable dispatchable PV panel product 325 to provide a low cost implementation for substantially higher volumetric and gravimetric densities with implementable communication techniques and bandwidth limitations associated with them. For one embodiment, the PV panel product 325 can achieve switching frequencies that are at least 500 kHz, which can allow for increased power densities. For one embodiment, one or more components of the PV panel product 325 include at least one of the following: (i) an inductor with an inductance of at least 0.25 Henry (H) required for low switching frequencies; and (ii) an inductor with an inductance with a range of 5 μH to 10 μH. For another embodiment, one or more components of the PV panel product 325 includes an inductor with an inductance with a range of 5 μH to 10 μH. The use of an inductor with a range of 5 μH to 10 μH enables miniaturization of the circuitry of the PV panel product 325 and enables the PV panel product 325 to operate without peer-level or peer-to-central communications. For a further embodiment, the information that is broadcasted to the control block 314 of the PV panel product 325 is a low bandwidth grid voltage zero-cross timing.

For one embodiment, the PV panel product 325 includes a voltage source monitoring/protection system that includes at least one of the following: (i) data-acquisition circuitry 313; (ii) operational amplifier (Op-Amp) based signal conditioning circuitry 313; or (iii) pulse width modulation (PWM) generation circuitry (not shown) most often inside the controller 309. For one embodiment, each of the data-acquisition circuitry 313, the Op-Amp based signal conditioning circuitry 307, and the PWM generation circuitry is implemented by the controller 309, which is a processor. For a further embodiment, the processor implementing circuits 313 and the PWM generation circuitry enables the monitoring or measuring of the data from the battery 317 to be performed in real-time or on-demand as may be needed. The dispatchable PV panel product 325 can also include a PV panel monitoring device that is described in detail in International patent application no. PCT/US2015/57907, filed Oct. 28, 2015. For the sake of brevity, only the voltage source monitoring/protection system of the PV panel product 325A is described below in connection with FIG. 3A.

As used herein, a “data-acquisition circuit” or its variations refer to one or more circuits configured to detect or measure battery data. Battery data is described above in connection with FIG. 1. For one embodiment, the data-acquisition circuit 313 includes at least one sensor that obtains the battery data from the battery 317.

As used herein, an “Op-Amp based signal conditioning circuit” or its variations refer to one or more circuits that process the battery data acquired by the data-acquisition circuitry 313. For one embodiment, the Op-Amp based signal conditioning circuit 313 interfaces with the data-acquisition circuit 313 to process the acquired battery data into one or more signals that are provided to a PWM generation circuit implemented by the controller 309.

As used herein, a “PWM generation circuit” or its variations refer to one or more circuits that generate one or more PWM signals for setting a switching frequency used to perform a sweep of a duty cycle of the high-voltage (HV) and/or low-voltage (LV) components of the dispatchable PV panel product 325. For example, and for one embodiment, the PWM generation circuit provides a first set of PWM signals to a component of the WEE circuit 305 and/or a second set of PWM signals to the bi-directional inverter 307. For this embodiment, a sweep of the duty cycle to vary the output current allows for capturing the IV characteristic of the PV 311. The IV characteristic is generally represented as an I-V curve, as is known in the art.

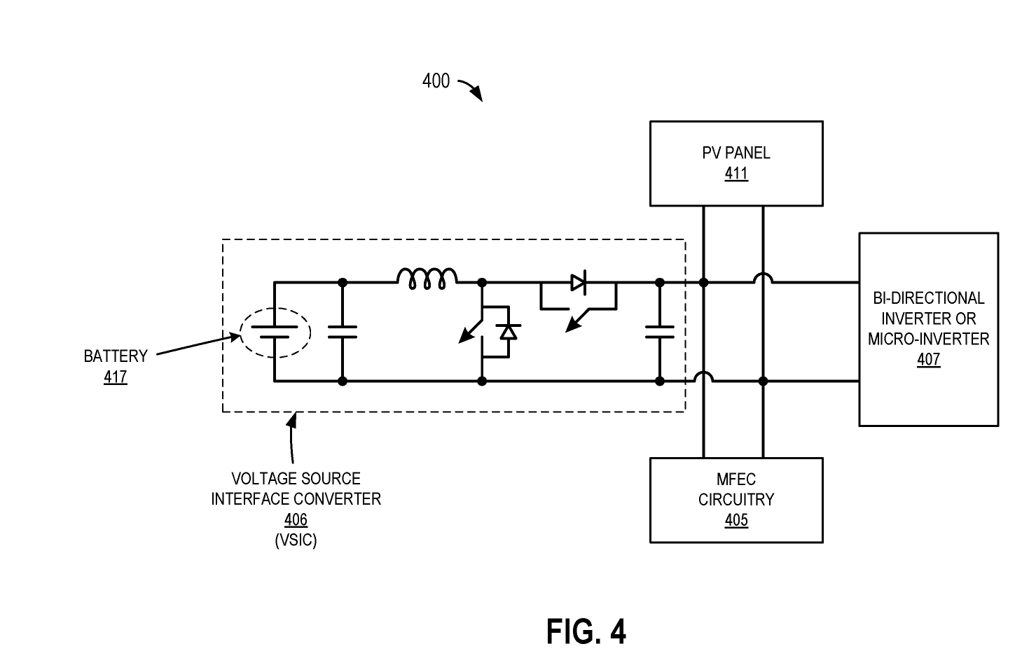

The data-acquisition circuitry 313 can obtain battery data from the battery 313. For one embodiment, the acquired battery data includes at least one of a voltage 304 (V_{BATT}) across the battery 317, a current (I_{BATT}) flowing through the battery 317, or at least one operating temperature (T_{BATT}) that is measured by an ambient temperature sensor 302, or a current of the inductor 432 (not shown in FIG. 4). For one embodiment, the acquired battery data only includes the voltage 304 (V_{BATT}) across the battery 317 and the current (I_{BATT}) flowing through the battery 317. For embodiments where the data-acquisition circuitry obtains at least one operating temperature (T_{BATT}), at least one of the V_{BATT} or the I_{BATT} is then correlated with the corresponding T_{BATT} and used to generate a charge/discharge profile for the battery 217. For example, and for one embodiment, at least one of the V_{BATT} or the I_{BATT} is expressed as a function of the T_{BATT}, to show in a charge/discharge curve that a capacity of a battery (e.g., a Lithium battery, a Li-Ion battery, etc.) varies with at least one of temperature, time, or discharge rate. Such a charge/discharge curve can show that at normal operating temperatures the coulombic efficiency of the battery is very high, but at low temperatures there is a major drop in efficiency particularly at high discharge rates which can be used to indicate an abnormal functioning of the battery.

Based on the acquired battery data (which includes at least one of the V_{BATT}, the I_{BATT}, or the T_{BATT}), the Op-Amp based signal conditioning circuitry 313 processes the acquired battery data, generates multiple signals based on the processing, and provides the multiple signals to the PWM generation circuitry implemented by the controller 309. For one embodiment, the multiple signals that are fed to the PWM generation circuitry enable the PWM generation circuitry to generate PWM signals that are used for controlling the HV and LV components of the PV panel product 325.

For one embodiment, the PWM generation circuitry provides a first PWM signal to the LV component of the MFEC circuitry 305, a second PWM signal to the HV component of MFEC circuitry 305, and a third set of PWM signals to the LV components of the bi-directional inverter 307. For one embodiment, the first PWM signal is used to control at least one of the I_{BATT} or the V_{BATT}. For example, and for one embodiment, the first PWM signal causes the switch of the LV component of the MFEC circuitry 305 to vary between “ON” and “OFF” states at a periodic rate. For this example, the varying of the switch of the LV component of the MFEC circuitry 305 between “ON” and “OFF” states at a periodic rate enables a control of at least one of I_{BATT} or the V_{BATT}. By using each of the signals generated by the PWM generation circuit, a capacity of the battery 317 of the PV panel product 325 may be estimated. For some embodiments, an IV sweep may be performed on the PV panel 311 of the PV panel product 325 to obtain an I-V curve for the PV panel product 317. Obtaining an I-V sweep for a PV panel (e.g., PV panel 311, etc.) is described in detail in International patent application no. PCT/US2015/57907, filed Oct. 28, 2015.

For one embodiment, the estimation of the capacity of the battery 317 is performed over a predetermined duration of time (e.g., an hourly basis, a daily basis, a weekly basis, a bi-weekly basis, etc.). Further, the estimated capacity of the battery 317 is correlated with the actual performance of the battery 317 to determine at least one of the following: (i) one or more key performance indicators (KPIs) of the battery 317; or (ii) a degradation profile of the battery 317.

As used herein, a “degradation profile” and its variations refer to a degradation rate of a battery (e.g., the battery 317, etc.). Thus, a degradation profile of a battery (e.g., the battery 317, etc.) indicates a quantification of a change in abilities of the battery (e.g., the battery 317, etc.) to discharge DC power over time for a given set of environmental conditions and/or to recharge using AC power over time for a given set of environmental conditions. For example, the change could be a decline in the abilities of the battery 317. For one embodiment, at least one of the KPIs or the degradation profile is used for fault diagnosis, fault detection, and/or yield prediction of a battery (e.g., the battery 317, etc.).

For one embodiment, at least one of the characteristics associated with the battery 317, the parameters associated with the battery 317, or the KPIs associated with the battery 317 is used by a cloud or appropriately situated system (e.g., system 108 of FIG. 1) to generate a charging/discharging profile of the battery 317. For one embodiment, the charging/discharging profile of the battery 317 is normalized to account for the variations in solar insolation and/or environmental conditions levels that affect the power generated by the PV panel 311. For one embodiment, the charging/discharging profile of the battery 317 is used by the VSIC 306A, the circuitry 313, and the controller 309 to control charging/discharging of the battery 317 and to protect the battery 317 from being damaged due to one or more hazardous conditions detected by the circuitry 313 and the controller 309. In this way, the charging/discharging profile of the battery 317 can assist with fault diagnosis, fault detection, and/or yield prediction of the battery 317. This is because the characteristics associated with the battery 317, the parameters associated with the battery 317, or the KPIs associated with the battery 317 within the normalized model should not vary unless the battery 317 is operating abnormally. Moreover, the charging/discharging profile of the battery 317 can assist with providing power to a load when the PV panel 311 has a low yield (e.g., at night when sunlight level are low, when cloud cover is high, etc.).

FIG. 3B is a block diagram illustration of a dispatchable PV panel product 325B, which includes multiple types of voltage sources 311 and 317 in accordance with an embodiment. The dispatchable PV panel product 325B of FIG. 3B is similar to or the same as the PV panel product 325A described above in connection with FIG. 3A. For the sake of brevity, only the differences between the product 325B and the product 325A are described below in connection with FIG. 3B.

One difference between the product 325B and the product 325A is that the product 325B includes a VSIC 306B. As shown in FIG. 3B, the VSIC 306B is connected, via the DC bus 399, to the battery 317. For one embodiment, the PV panel 311 charges the battery 317 via the VSIC 306B if all of the energy generated by the PV panel 311 is not routed to an electrical load (e.g., an AC grid, etc.). For one embodiment, all DC power is routed to the panel level inverter for delivery to an electrical load (e.g., an AC grid, etc.). The VSIC 306B can also be referred to as a PV panel interface converter. For one embodiment, the VSIC 306B controls a maximum power point tracking (MPPT) of the PV panel 311. In this way, the VSIC 306B varies the electrical operating point of the PV panel 311 so that the PV panel 311 delivers its maximum available power. For one embodiment, the bi-directional inverter 307 of product 325B addresses any requirements of an electrical load (e.g., an electrical grid, etc.), while also acting as a charge/discharge manager of the battery 317.

Another difference is that the product 325B includes an ambient temperature sensor 321, which can be used for obtaining temperature measurements associated with the PV panel 311 at one or more solar insolation levels. These obtained measurements from the sensor 321 can be used for several functions, including monitoring of the functioning of the PV panel 311 and generating/maintaining a dynamically updated panel model for the PV panel 311. The use of an ambient temperature sensor 321 with a PV panel product 311 is described in detail in International patent application no. PCT/US2015/57907, filed Oct. 28, 2015.

For one embodiment of product 325B, an IV sweep can be performed on the PV panel 311. For one embodiment, at least one of the ambient temperature (Tpv) 398, the PV voltage (Vpv) 319, or the PV current (Ipv) 397 is used to perform the IV sweep. IV sweeps of a PV panel (e.g., PV panel 311, etc.) are described in detail in International patent application no. PCT/US2015/57907, filed Oct. 28, 2015. For one embodiment, the IV sweep is performed on the PV panel 311 at varying solar insolation levels and/or environmental conditions (e.g., wind speeds, sunlight, temperature, other weather effects, etc.) that occur throughout a predetermined duration of time (e.g. a day, a week, etc.). As a first example, an IV sweep that is performed on the PV panel 311 is performed at a solar insolation level that occurs in the morning when environmental conditions related to humidity levels can be accounted for. As a second example, an IV sweep that is performed on the PV panel 311 is performed at a solar insolation level that occurs in middle of the day when environmental conditions related to the amount of sunlight can be accounted for (e.g., when the sun is brightest and high in the sky). Further, the data gathered from the IV sweep (e.g., the I-V curve) that is performed on the PV panel 311 is correlated with the actual performance of the PV panel 311 to determine one or more key performance indicators (KPIs) of the PV panel 311.

FIG. 3C is a block diagram illustration of a dispatchable PV panel product 325C, which includes multiple types of voltage sources 311 and 317 in accordance with an embodiment. The dispatchable PV panel product 325C of FIG. 3C is similar to or the same as the PV panel products 325A-B described above in connection with FIGS. 3A-B. For the sake of brevity, only the differences between the product 325C and the products 325A-B are described below in connection with FIG. 3C.

One difference between the product 325C and the products 325A-B is that the product 325B includes both the VSIC 306A and the VSIC 306B. As shown in FIG. 3C, the VSIC 306A and the VSIC 306B are respectively connected, via the DC bus 399, to the MFEC 305 and the bi-directional inverter 307. Each of the VSIC 306A and the VSIC 306B are described above in connection with FIGS. 3A-3B.

As shown in FIG. 3C, product 325C does not include the sensors 302 described above in connection with FIG. 3A or the sensor 321 described above in connection with FIG. 3B; however, these sensors can be included in product 325C.

FIG. 4 is a schematic illustration of a dispatchable PV panel product 400, which includes multiple types of voltage sources 411 and 417 in accordance with another embodiment. The dispatchable PV panel product 400 of FIG. 4 provides additional details about the dispatchable PV panel product 200 of FIGS. 2A-2B.

For one embodiment, the PV panel product 400 includes the following: (i) a battery 417, which is similar to or the same as the battery 317 described above in connection with FIG. 3; (ii) a VSIC 406, which is similar to or the same as the VSIC 306A or the VSIC 306B described above in connection with FIGS. 3A-3C; (iii) MFEC circuitry 405, which is similar to or the same as the WEE circuitry 305 described above in connection with FIGS. 3A-3C; (iv) a bi-directional inverter 407, which is similar to or the same as the bi-directional inverter 307 described above in connection with FIGS. 3A-3C; and (v) a PV panel 411, which is similar to or the same as the PV panel 311 described above in connection with FIGS. 3A-3C. Other components of the PV panel product 400 are not shown to avoid obscuring the inventive concepts described below in connection with FIG. 4.

For one embodiment, the VSIC 406 includes several components including at least one of a capacitor, an inductor, a HV component (e.g., a MOSFET, an IGBT with an anti-parallel ultrafast diode, etc.), or a LV component (e.g., a MOSFET, a Schottky diode combination, etc.) For one embodiment, the VSIC 406 controls varying voltages of the PV panel 411 and the battery 417 of the dispatchable PV panel product 400. As shown in FIG. 4, the VSIC 406 couples the battery 417 to the DC bus of the PV panel. For one embodiment, the VSIC 406 is a bidirectional VSIC that allows voltage matching of the PV panel 411 and the battery 417. For one embodiment, the VSIC 406 is a bidirectional VSIC that controls the charge/discharge profile for the battery 417, as described above in connection with at least one of FIGS. 1-3. For one embodiment, the Multi-Frequency Energy Coupling (MFEC) circuit 407 serves the function balancing instantaneous AC and DC power between input DC power and output DC power.

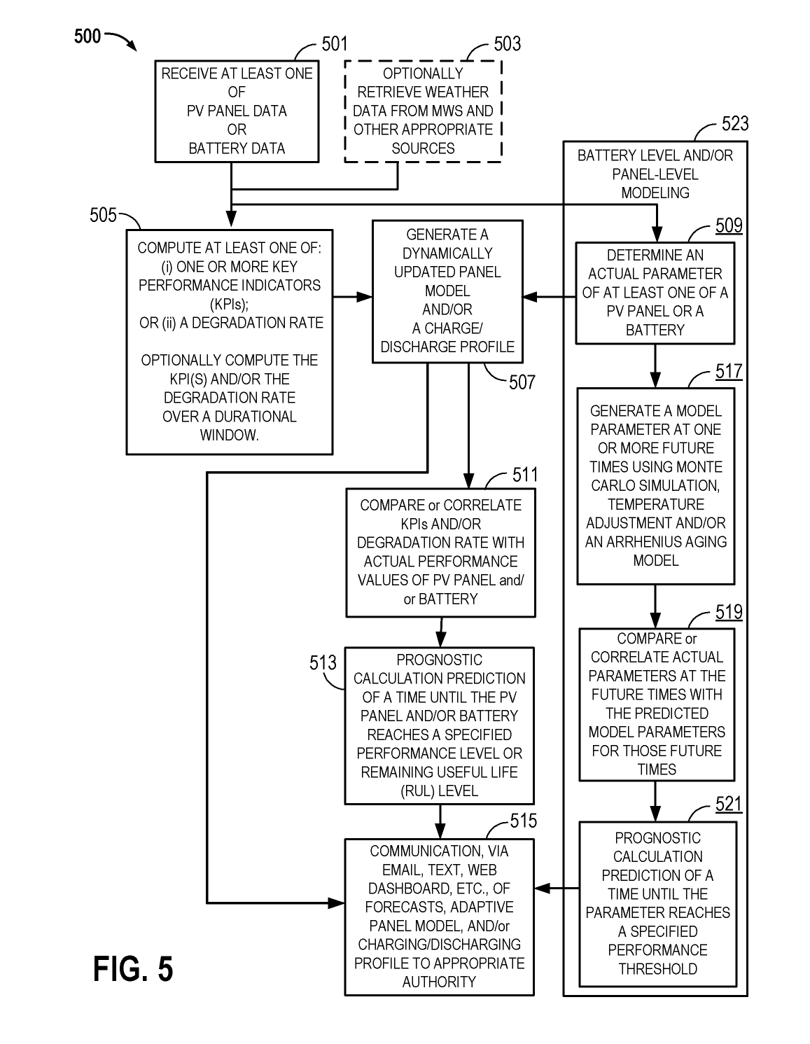

FIG. 5 is a representative flow chart illustration of process 500 of fault detection, fault diagnosis, and/or yield prediction in accordance with one embodiment. Each of the blocks of process 500 can be performed by one or more of the components of the systems, devices, and/or computers described above in connection with at least one of FIGS. 1-4. For example, the system 100 of FIG. 1 can perform process 500.

Process 500 begins at blocks 501 and 503. At block 501, a cloud or appropriately situated system (e.g., the cloud or appropriately situated system 108 described above in connection with FIG. 1) receives at least one of acquired PV panel data for a PV panel or acquired battery data for a battery. As explained above in connection with at least one of FIGS. 1-4, a PV panel product can include multiple types of voltage sources (e.g., a battery and a PV panel comprised of at least one PV cell, etc.).

Moreover, weather information can also optionally be retrieved by the cloud or appropriately situated system from a weather prediction system (e.g., the weather prediction system 109 described above in connection with FIG. 1). Acquisition of PV panel data and/or battery data is described above in connection with at least FIGS. 1-4. Retrieval of weather data is described above in connection with at least FIG. 1.

At block 505, the cloud or appropriately situated system computes at least one of a KPI of the PV panel, a degradation rate of the PV panel, a KPI of the battery, or a degradation rate of the battery. For a further embodiment, the cloud or appropriately situated system computes at least one KPI for the PV panel (e.g., a future yield, a future current, or a future voltage of the PV panel) and/or at least one KPI for the battery (e.g., a future yield, a future current, or a future voltage of the battery). For yet another embodiment, at least one of a KPI of the PV panel, a degradation rate of the PV panel, a KPI of the battery, or a degradation rate of the battery is computed over a durational window. KPIs, degradation rates, and durational windows are described above in connection with at least FIGS. 1-4. Furthermore, the cloud or appropriately situated system determines actual parameters for at least one of the PV panel or the battery at block 509. Actual parameters are described above in connection with at least FIGS. 3A-4. In block 507, the cloud or appropriately situated system uses the outputs of blocks 505 and 509 to generate at least one of a charging/discharging profile for the battery or a dynamically updated panel model for the PV panel. The generation at least one of a charging/discharging profile for the battery or a dynamically updated panel model for the PV panel is described above in connection with at least FIGS. 1 and 3A-4. At block 515, at least one of a charging/discharging profile for the battery or a dynamically updated panel model for the PV panel can be reported to a remote monitoring system associated with a third party (e.g., remote monitoring system 106 described above in connection with FIG. 1).

At block 511, the cloud or appropriately situated system performs the following: (i) compares or correlates at least one of a KPI of the PV panel or a degradation rate of the PV panel with the actual performance of the PV model; and (ii) compares or correlates at least one of a KPI of the battery or a degradation rate of the battery with the actual performance of the battery. At block 513, the cloud or appropriately situated system uses the results of the comparison or correlation performed in block 611 to predict a future time when the PV panel or the battery will reached a specified remaining useful life (RUL) level. These prediction mechanisms are known in the art, and as a result, they will not be described in detail.

With regard to the parameters of the PV panel and the battery, the cloud or appropriately situated system generates model parameters at future times using at least one of a Monte Carlo simulation, a temperature adjustment model, an Arrhenius aging model, or other methodologies used for future prediction as known in the art at block 517. For a first example, and for one embodiment, an aging model that is normalized for operating temperatures of a battery is used for estimating an Amp-hour capacity of a battery over an extended period of time (e.g., a day, several days, a week, several weeks, a month, several months, a year, several years, etc.) before the battery's voltage reaches the end-of-life point. For a second example, and for one embodiment, an aging model that is normalized for weather conditions is used for estimating the shunt resistance associated with a PV panel. Specifically, this normalized shunt resistance will be aged using the following equation Rₛₕ=R_{sh,0}×e^{(a×t)}, where Rₛₕ represents the shunt resistance, t represents time since the panel was first deployed, R_{sh,0} represents the initial value of Rₛₕ when first measured at t=0 (i.e. the first measurement ever made after deploying the panel), and a represents a constant value (in ideal situations) or a slowly varying constant (that changes over time).

Further, at block 519, the cloud or appropriately situated system compares the actual parameters at those future times with the predicted model parameters of block 517. At block 521, the cloud or appropriately situated system uses the results of block 519 to predict a time when the actual parameter will reach a specified performance threshold.

At block 515, the cloud or appropriately situated system reports the forecasts determined in blocks 513 and 521 to a remote monitoring computer or system associated with a third party (e.g., an electrical utilities company, an ISO, a plant dispatcher, etc.) that uses the forecasts for controlling power generation and distribution. For example, based on a predicted performance threshold of a dispatchable PV panel that is part of a PV panel product (e.g., the PV panel product 100 of FIG. 1, etc.), the third party or the system owner or plant operator may determine that the power being discharged to a load should be switched from being provided by the PV panel to the battery that is part of a dispatchable PV panel product.

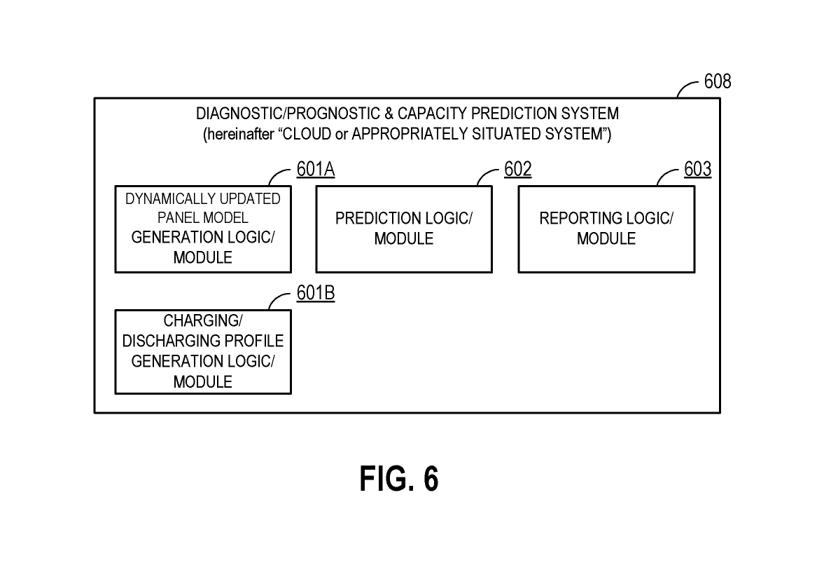

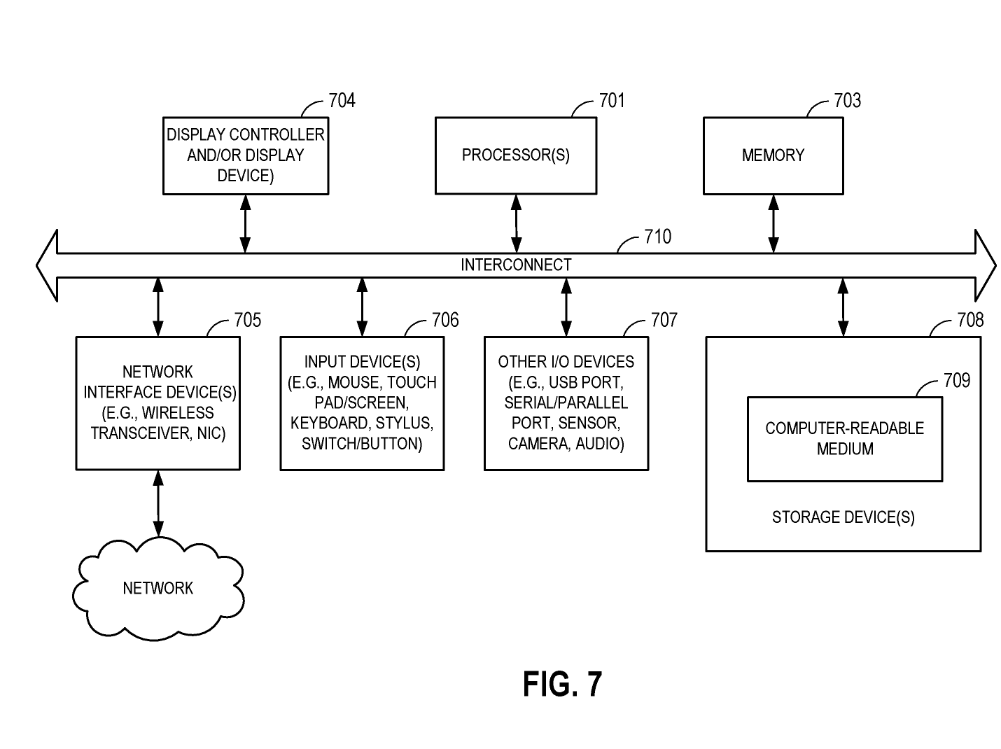

FIG. 6 is a block diagram illustration of the cloud or appropriately situated system 608 in accordance with one embodiment. For one embodiment, the system 608 is similar to or the same as the system 108 described above in connection with FIG. 1. The system 608 can be include at least one data processing system, such as the data processing 700 described below in connection with FIG. 7. For one embodiment, the system 608 includes a dynamically updated panel model generation logic/module 601A and a charging/discharging profile generation module 601B. The logic/modules 601A-B performs the generation of the adaptive panel and the generation of the charging/discharging profile as described above in at least one FIGS. 1-5. For example, the logic/modules 601A-B perform each of the operations of blocks 501, 503, 505, and 509 of process 500, which is described above in connection with FIG. 5. For one embodiment, the system 608 includes a prediction logic/module 602 that performs the prediction of power capacity or degradation of at least one of a battery or a PV panel as described above in at least one of FIGS. 1-5. For example, the prediction logic/module 602 performs each of the operations of blocks 511, 513, 517, 519, and 521 of process 500, which is described above in connection with FIG. 5. For an embodiment, the system 608 includes a reporting logic/module 603 that reports the outputs of the logic/module 601 and the logic/module 602 to a remote monitoring system associated with a third party (e.g., remote monitoring system 106 described above in connection with FIG. 1). For example, the reporting logic/module 603 performs each of the reporting operations of block 515, which is described above in connection with FIG. 5.

FIG. 7 is a block diagram illustrating an example of a data processing system 700 that may be used with at least one of the embodiments described herein. For example, system 700 may represent a data processing system for performing any of the processes or methods described above in connection with any of FIGS. 1-6. System 700 can include many different components. These components can be implemented as integrated circuits (ICs), portions thereof, discrete electronic devices, or other modules adapted to a circuit board such as a motherboard or add-in card of the computer system, or as components otherwise incorporated within a chassis of the computer system. Note also that system 700 is intended to show a high-level view of many components of the computer system. However, it is to be understood that additional components may be present in certain implementations and furthermore, different arrangement of the components shown may occur in other implementations. System 700 may represent a desktop, a laptop, a tablet, a server, a mobile phone, a media player, a personal digital assistant (PDA), a personal communicator, a gaming device, a network router or hub, a wireless access point (AP) or repeater, a set-top box, or a combination thereof. Further, while only a single machine or system is illustrated, the term “machine” or “system” shall also be taken to include any collection of machines or systems that individually or jointly execute a set (or multiple sets) of instructions to perform any one or more of the methodologies discussed herein.

In one embodiment, system 700 includes processor 701, memory 703, and devices 705-708 via a bus or an interconnect 710. Processor 701 may represent a single processor or multiple processors with a single processor core or multiple processor cores included therein. Processor 701 may represent one or more general-purpose processors such as a microprocessor, a central processing unit (CPU), or the like. More particularly, processor 701 may be a complex instruction set computing (CISC) microprocessor, reduced instruction set computing (RISC) microprocessor, very long instruction word (VLIW) microprocessor, or processor implementing other instruction sets, or processors implementing a combination of instruction sets. Processor 701 may also be one or more special-purpose processors such as an application specific integrated circuit (ASIC), a cellular or baseband processor, a field programmable gate array (FPGA), a digital signal processor (DSP), a network processor, a graphics processor, a network processor, a communications processor, a cryptographic processor, a co-processor, an embedded processor, or any other type of logic capable of processing instructions.

Processor 701, which may be a low power multi-core processor socket such as an ultra-low voltage processor, may act as a main processing unit and central hub for communication with the various components of the system. Such processor can be implemented as a system on chip (SoC). Processor 701 is configured to execute instructions for performing the operations and/or steps discussed herein. System 700 may further include a graphics interface that communicates with optional graphics subsystem 704, which may include a display controller, a graphics processor, and/or a display device.

Processor 701 may communicate with memory 703, which in one embodiment can be implemented via multiple memory devices to provide for a given amount of system memory. Memory 703 may include one or more volatile storage (or memory) devices such as random access memory (RAM), dynamic RAM (DRAM), synchronous DRAM (SDRAM), static RAM (SRAM), or other types of storage devices. Memory 703 may store information including sequences of instructions that are executed by processor 701 or any other device. For example, executable code and/or data of a variety of operating systems, device drivers, firmware (e.g., input output basic system or BIOS), and/or applications can be loaded in memory 703 and executed by processor 701. An operating system can be any kind of operating systems, such as, for example, Windows® operating system from Microsoft®, Mac OS®/iOS® from Apple, Android® from Google®, Linux®, Unix®, or other real-time or embedded operating systems such as VxWorks.

System 700 may further include I/O devices such as devices 705-708, including network interface device(s) 705, optional input device(s) 706, and other optional IO device(s) 707. Network interface device 705 may include a wireless transceiver and/or a network interface card (NIC). The wireless transceiver may be a WiFi transceiver, an infrared transceiver, a Bluetooth transceiver, a WiMax transceiver, a wireless panel assembly telephony transceiver, a satellite transceiver (e.g., a global positioning system (GPS) transceiver), or other radio frequency (RF) transceivers, or a combination thereof. The NIC may be an Ethernet card.

Input device(s) 706 may include a mouse, a touch pad, a touch sensitive screen (which may be integrated with display device 704), a pointer device such as a stylus, and/or a keyboard (e.g., physical keyboard or a virtual keyboard displayed as part of a touch sensitive screen). For example, input device 706 may include a touch screen controller coupled to a touch screen. The touch screen and touch screen controller can, for example, detect contact and movement or a break thereof using any of multiple touch sensitivity technologies, including but not limited to capacitive, resistive, infrared, and surface acoustic wave technologies, as well as other proximity sensor arrays or other elements for determining one or more points of contact with the touch screen.

I/O devices 707 may include an audio device. An audio device may include a speaker and/or a microphone to facilitate voice-enabled functions, such as voice recognition, voice replication, digital recording, and/or telephony functions. Other IO devices 707 may further include universal serial bus (USB) port(s), parallel port(s), serial port(s), a printer, a network interface, a bus bridge (e.g., a PCI-PCI bridge), sensor(s) (e.g., a motion sensor such as an accelerometer, gyroscope, a magnetometer, a light sensor, compass, a proximity sensor, etc.), or a combination thereof. Devices 707 may further include an imaging processing subsystem (e.g., a camera), which may include an optical sensor, such as a charged coupled device (CCD) or a complementary metal-oxide semiconductor (CMOS) optical sensor, utilized to facilitate camera functions, such as recording photographs and video clips. Certain sensors may be coupled to interconnect 1510 via a sensor hub (not shown), while other devices such as a keyboard or thermal sensor may be controlled by an embedded controller (not shown), dependent upon the specific configuration or design of system 700.

To provide for persistent storage of information such as data, applications, one or more operating systems and so forth, a mass storage (not shown) may also couple to processor 701. In various embodiments, to enable a thinner and lighter system design as well as to improve system responsiveness, this mass storage may be implemented via a solid state device (SSD). However in other embodiments, the mass storage may primarily be implemented using a hard disk drive (HDD) with a smaller amount of SSD storage to act as a SSD cache to enable non-volatile storage of context state and other such information during power down events so that a fast power up can occur on re-initiation of system activities. In addition, a flash device may be coupled to processor 701, e.g., via a serial peripheral interface (SPI). This flash device may provide for non-volatile storage of system software, including a basic input/output software (BIOS) as well as other firmware of the system.

Storage device 708 may include computer-accessible storage medium 709 (also known as a machine-readable storage medium or a computer-readable medium) on which is stored one or more sets of instructions or software embodying any one or more of the methodologies or functions described herein. Embodiments described herein (e.g., the process 500 described above in connection with FIG. 5) may also reside, completely or at least partially, within memory 703, and/or within processor 701 during execution thereof by data processing system 700, memory 703, and processor 701 also constituting machine-accessible storage media. Modules, units, or logic configured to implement the embodiments described herein (e.g., the process 500 described above in connection with FIG. 5) may further be transmitted or received over a network via network interface device 705.

Computer-readable storage medium 709 may also be used to store some software functionalities described above persistently. While computer-readable storage medium 709 is shown in an exemplary embodiment to be a single medium, the term “computer-readable storage medium” should be taken to include a single medium or multiple media (e.g., a centralized or distributed database, and/or associated caches and servers) that store the one or more sets of instructions. The terms “computer-readable storage medium” shall also be taken to include any medium that is capable of storing or encoding a set of instructions for execution by the machine and that cause the machine to perform any one or more of the methodologies of the embodiments described herein. The term “computer-readable storage medium” shall accordingly be taken to include, but not be limited to, solid-state memories, and optical and magnetic media, or any other non-transitory machine-readable medium.

Components and other features described herein can be implemented as discrete hardware components or integrated in the functionality of hardware components such as ASICS, FPGAs, DSPs, or similar devices. In addition, any of the components described above in connection with any one of FIGS. 1-6 can be implemented as firmware or functional circuitry within hardware devices. Further, these components can be implemented in any combination hardware devices and software components.

Note that while system 700 is illustrated with various components of a data processing system, it is not intended to represent any particular architecture or manner of interconnecting the components; as such, details are not germane to embodiments described herein. It will also be appreciated that network computers, handheld computers, mobile phones, servers, and/or other data processing systems, which have fewer components or perhaps more components, may also be used with embodiments described herein.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities.

It should be borne in mind, however, that all of these and similar terms are to be associated with the appropriate physical quantities and are merely convenient labels applied to these quantities. Unless specifically stated otherwise as is apparent from the above discussion, it is appreciated that throughout the description, some of the discussions utilizing terms such as those set forth in the claims below, may refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments described herein also relate to an apparatus for performing the operations herein. Such a computer program is stored in a non-transitory computer readable medium. A machine-readable medium includes any mechanism for storing information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices).

The processes or methods depicted in the preceding figures may be performed by processing logic that comprises hardware (e.g. circuitry, dedicated logic, etc.), software (e.g., embodied on a non-transitory computer readable medium), or a combination of both. Although the processes or methods are described above in terms of some sequential operations, it should be appreciated that some of the operations described may be performed in a different order. Moreover, some operations may be performed in parallel rather than sequentially.

Embodiments described herein are not described with reference to any particular programming language. It will be appreciated that a variety of programming languages may be used to implement the teachings of the embodiments described herein.

In the foregoing specification, embodiments set forth herein have been described with reference to specific exemplary embodiments thereof. It will be evident that various modifications may be made thereto without departing from the broader spirit and scope of one or more of the inventive concepts as set forth in the following claims. The specification and drawings are, accordingly, to be regarded in an illustrative sense rather than a restrictive sense.

References in the specification to “one embodiment,” “an embodiment,” “an exemplary embodiment,” etc., indicate that the embodiment described may include a particular feature, structure, or characteristic, but not every embodiment may necessarily include the particular feature, structure, or characteristic. Moreover, such phrases are not necessarily referring to the same embodiment. Furthermore, when a particular feature, structure, or characteristic is described in connection with an embodiment, such feature, structure, or characteristic may be implemented in connection with other embodiments whether or not explicitly described. Additionally, as used herein, the term “exemplary” refers to embodiments that serve as simply an example or illustration. The use of exemplary should not be construed as an indication of preferred examples. Numerous specific details are described to provide a thorough understanding of various embodiments described herein. However, in certain instances, well-known or conventional details are not described in order to provide a concise discussion of embodiments described herein.

In the description and claims set forth herein, the terms “coupled” and “connected,” along with their derivatives, may be used. It should be understood that these terms are not intended as synonyms for each other. “Coupled” and its variations are used to indicate that two or more elements, which may or may not be in direct physical or electrical contact with each other, co-operate or interact with each other. “Connected” and its variations are used to indicate the establishment of communication between two or more elements that are coupled with each other. For example, two devices that are connected to each other are communicatively coupled to each other. “Communication” and its variations includes at least one of transmitting or forwarding of information to an element or receiving of information by an element. The terms “system,” “device,” “computer,” “terminal,” and their respective variations are intended to refer generally to data processing systems (e.g., the data processing system 700 described above in connection with FIG. 7) rather than specifically to a particular form factor for the system and/or device. It will be evident that various modifications may be made to the embodiments described herein without departing from the broader spirit and scope of the claimed embodiments.

What is claimed is:

1. A dispatchable photovoltaic (PV) panel product comprising:
a photovoltaic (PV) panel comprising a plurality of PV cells, the PV panel configured to generate direct current (DC) power;
a battery configured to generate direct current (DC) power; and
a voltage source interface converter (VSIC) coupled to at least one of the battery or the PV panel, wherein the VSIC is a bidirectional converter that allows voltage matching of the battery and the PV panel, wherein the VSIC enables charging of the battery directly from the PV, and wherein the VSIC controls charging or discharging of power to or from the battery using a charge/discharge profile for the battery; and
a panel level inverter coupled to the VSIC and at least one of at least one of the battery or the PV panel, the panel level inverter being configured to (i) convert the DC power into alternating current (AC) power for an electrical load, (ii) charge the battery by the VSIC using at least one of the DC power generated by the PV panel or the AC power, and (iii) discharge the battery to the AC power of the electrical load,

2. The dispatchable PV panel product of claim 1, further comprising a battery panel assembly (BPA), wherein the battery is housed in the BPA.

3. The dispatchable PV panel product of claim 2, wherein an air gap exists between the PV panel and the battery to provide thermal and electrical isolation between the PV panel and the battery.

4. The dispatchable PV panel product of claim 1, further comprising:
a plurality of heat pipes to dissipate excess heat from at least one of the battery or the BPA.

5. The dispatchable PV panel product of claim 1, wherein the panel mounted inverter further includes:
a battery protection system configured to:
detect one or more potential hazardous situations associated with the battery; and
initiate a shutdown of at least one of the battery or the PV panel in response to the detection.

6. The dispatchable PV panel product of claim 1, wherein the panel mounted inverter further includes:
a voltage source monitoring system comprising a processing device, the processing device executing instructions that cause the voltage source monitoring system to monitor a condition of the battery, wherein:
the monitored condition of the battery is converted into electronic data that is used to create the charge/discharge profile for the battery; and
the processing device executing instructions that cause the voltage source monitoring system to monitor a condition of the PV panel, wherein:
the monitored condition of the battery is converted into electronic data that is used to create a dynamically updated panel model for the battery.

7. The dispatchable PV panel product of claim 6, wherein the monitored condition of the battery includes at least one of:
an actual yield of the battery, the actual yield of the battery being a measure of energy derived from power generated by the battery;
a temperature characteristic of the battery;
a voltage characteristic of the battery; or
a current characteristic of the battery.

8. The dispatchable PV panel product of claim 6, wherein the monitored condition of the first PV panel includes at least one of:
an actual yield of the PV panel, the actual yield of the PV panel being a measure of energy derived from power generated by the PV panel;
a temperature characteristic of the PV panel;
a voltage characteristic of the PV panel; or
a current characteristic of the PV panel.

9. The dispatchable PV panel product of claim 6, wherein the monitoring is performed in real-time or on-demand.

10. The dispatchable PV panel product of claim 6, wherein at least one of a key performance indicator (KPI) of the PV panel, a degradation profile of the PV panel, a KPI of the battery, a degradation profile of the battery is generated over a durational window based on the charging/discharging profile of the battery and the dynamically updated panel model of the PV panel.

11. The dispatchable PV panel product of claim 10, wherein:
the KPI of the battery is indicative of at least one of a future yield of the battery, a predicted maximum capacity of the battery, and the degradation profile of the battery being indicative of a quantification of a decline in an ability of the battery to charge or discharge power over time; and
the KPI of the PV panel is indicative of at least one of a future yield of the PV panel, a predicted maximum power of the PV panel, a predicted voltage at a predicted maximum power of the PV panel, and a predicted current at a predicted maximum power of the PV panel, and the degradation profile of the PV panel being indicative of a quantification of a decline in an ability of the PV panel to generate power over time.

12. The dispatchable PV panel product of claim 11, wherein:
at least one of energy rate arbitrage, supply shifting, PV smoothing, or a grid functionality is performed based on at least one of the KPI of the battery, the KPI of the PV panel, the degradation profile of the battery, or the degradation profile of the PV panel.

13. The dispatchable PV panel product of claim 10, wherein the generation of at least one of at least one of a key performance indicator (KPI) of the PV panel, a degradation profile of the PV panel, a KPI of the battery, a degradation profile of the battery is based on weather data.

14. A system comprising one or more processing devices, the one or more processing devices being configured to:
monitor, by at least one monitoring device, at least one of a condition of the battery or a condition of the PV panel,
wherein a dispatchable PV panel product includes the battery, the PV panel, and an panel level inverter that is coupled to the battery and the PV panel,
wherein each of the battery and the PV panel is configured to generate direct current (DC) power,
wherein the panel level inverter is configured to convert the DC power into alternating current (AC) power and discharge the AC power to an electrical load,
wherein the panel mounted inverter includes the monitoring device and a voltage source interface converter (VSIC), wherein the VSIC is a bidirectional converter that allows voltage matching of the battery and the PV panel,
wherein the VSIC enables charging of the battery directly from the PV, and
wherein the VSIC controls charging or discharging of power to or from the battery using a charge/discharge profile for the battery;
process electronic data representing the monitored conditions by the one or more processing devices;
create the charge/discharge profile for the battery, and
create a dynamically updated PV panel model for the PV panel.

15. The system of claim 14, wherein the one or more processing devices are further configured to:
detect one or more potential hazardous situations associated with the battery; and
initiate a shutdown of at least one of the battery or the PV panel in response to the detection.

16. The system of claim 14, wherein:
the monitored condition of the battery includes at least one of:
an actual yield of the battery, the actual yield of the battery being a measure of energy derived from power generated by the battery;
a temperature characteristic of the battery;
a voltage characteristic of the battery; or
a current characteristic of the battery; and
the monitored condition of the first PV panel includes at least one of:
an actual yield of the PV panel, the actual yield of the PV panel being a measure of energy derived from power generated by the PV panel;
a temperature characteristic of the PV panel;
a voltage characteristic of the PV panel; or
a current characteristic of the PV panel.

17. The system of claim 14, wherein the monitoring is performed in real-time or on-demand.

18. The system of claim 14, wherein at least one of a key performance indicator (KPI) of the PV panel, a degradation profile of the PV panel, a KPI of the battery, a degradation profile of the battery is generated over a durational window based on the charging/discharging profile of the battery and the dynamically updated PV panel model of the PV panel.

19. The system of claim 18, wherein:
the KPI of the battery is indicative of at least one of a future yield of the battery, a predicted maximum capacity of the battery, and the degradation profile of the battery being indicative of a quantification of a decline in an ability of the battery to charge or discharge power over time; and
the KPI of the PV panel is indicative of at least one of a future yield of the PV panel, a predicted maximum power of the PV panel, a predicted voltage at a predicted maximum power of the PV panel, and a predicted current at a predicted maximum power of the PV panel, and the degradation profile of the PV panel being indicative of a quantification of a decline in an ability of the PV panel to generate power over time.

20. The system of claim 19, wherein:
at least one of energy rate arbitrage, supply shifting, PV smoothing, or a grid functionality is performed based on at least one of the KPI of the battery, the KPI of the PV panel, the degradation profile of the battery, or the degradation profile of the PV panel.
